(19) United States
(12) Patent Application Publication
(10) Pub. No.: US 2011/0117852 A1
(43) Pub. Date: May 19, 2011

(54) AD HOC WIRELESS COMMUNICATIONS

(76) Inventors: Gregory Clark Copeland, Plano, TX (US); Scott Y. Seidel, Fairfax, VA (US)

(21) Appl. No.: 13/054,154

(22) PCT Filed: Jul. 22, 2009
(86) PCT No.: PCT/US09/51467

§ 371 Date: Jan. 14, 2011

Related U.S. Application Data
(60) Provisional application No. 61/082,618, filed on Jul. 22, 2008.
(60) Provisional application No. 61/082,642, filed on Jul. 22, 2008.
(60) Provisional application No. 61/084,738, filed on Jul. 30, 2008.
(60) Provisional application No. 61/084,773, filed on Jul. 30, 2008.
(60) Provisional application No. 61/086,242, filed on Aug. 5, 2008.
(60) Provisional application No. 61/094,584, filed on Sep. 5, 2008.
(60) Provisional application No. 61/094,591, filed on Sep. 5, 2008.
(60) Provisional application No. 61/094,594, filed on Sep. 5, 2008.
(60) Provisional application No. 61/094,546, filed on Sep. 5, 2008.
(60) Provisional application No. 61/094,611, filed on Sep. 5, 2008.
(60) Provisional application No. 61/095,298, filed on Sep. 8, 2008.
(60) Provisional application No. 61/095,310, filed on Sep. 9, 2008.
(60) Provisional application No. 61/103,106, filed on Oct. 6, 2008.
(60) Provisional application No. 61/111,384, filed on Nov. 5, 2008.
(60) Provisional application No. 61/112,131, filed on Nov. 6, 2008.
(60) Provisional application No. 61/118,232, filed on Nov. 26, 2008.
(60) Provisional application No. 61/121,169, filed on Dec. 9, 2008.

(51) Int. Cl. H04B 15/00

(52) U.S. Cl. 455/62

(57) ABSTRACT

Various techniques are disclosed for improving the use of a dynamic, multi-channel communication medium in a wireless ad hoc network or the like. In general, metadata including node and/or network information or the like is shared among nodes in a network, and this data is used to improve throughput, reduce spectral footprint or power footprint for a group of nodes, or otherwise improve performance of the network.

### RELATED APPLICATIONS

This application is a national stage filing under 35 U.S.C. §371 of published International Application No. PCT/US09/51467 filed on Jul. 22, 2009, which is incorporated herein by reference in its entirety. International application PCT/US09/51467 was published in English as Publication No. WO 2010/011796.

International Application PCT/US09/51467 claims priority to the following U.S. Provisional Patent Applications, each of which is hereby incorporated by reference in its entirety: U.S. App. No. 61/082,618 filed on Jul. 22, 2008; U.S. App. No. 61/082,642 filed on Jul. 22, 2008; U.S. App. No. 61/086,242 filed on Aug. 5, 2008; U.S. App. No. 61/084,738 filed on Jul. 30, 2008; U.S. App. No. 61/084,773 filed on Jul. 30, 2008; U.S. App. No. 61/094,546 filed on Sep. 5, 2008; U.S. App. No. 61/118,232 filed on Nov. 26, 2008; U.S. App. No. 61/094,584 filed on Sep. 5, 2008; U.S. App. No. 61/094,591 filed on Sep. 5, 2008; U.S. App. No. 61/094,594 filed on Sep. 5, 2008; U.S. App. No. 61/094,611 filed on Sep. 5, 2008; U.S. App. No. 61/095,298 filed on Sep. 8, 2008; U.S. App. No. 61/095,310 filed on Sep. 9, 2008; U.S. App. No. 61/103,106 filed on Oct. 6, 2008; U.S. App. No. 61/111,384 filed on Nov. 5, 2008; U.S. App. No. 61/112,131 filed on Nov. 6, 2008; and U.S. App. No. 61/121,169 filed on Dec. 9, 2008.

### SUMMARY

Various techniques are disclosed for improving the use of a dynamic, multi-channel communication medium in a wireless ad hoc network or the like. In general, metadata including node and/or network information or the like is shared among nodes in a network, and this data is used to improve throughput, reduce spectral footprint or power footprint for a group of nodes, or otherwise improve performance of the network.

In one aspect, a method that is disclosed herein includes operating a node in a wireless ad hoc network wherein a plurality of nodes in a neighborhood, that includes the node, share a channelized medium that permits concurrent data communications using two or more channels, the method comprising: exchanging metadata with each other one of the plurality of nodes in the neighborhood, thereby providing a common view of metadata for each one of the plurality of nodes in the neighborhood; selecting a single one of the plurality of nodes to be a receiving node based upon the metadata, wherein each one of the plurality of nodes applies the common view of the metadata and a common scheduling function to select the receiving node; and either transmitting data, if any, to the receiving node when the node is not the receiving node or receiving data from the plurality of nodes when the node is the receiving node. The metadata may include a unique identifier for each one-hop neighbor of each one of the plurality of nodes. In some embodiments the metadata may include link quality data for a data link between two or more of the plurality of nodes. The common scheduling function may include a hash function, and wherein selecting the single one of the plurality of nodes includes applying a unique identifier for the node to the hash function. In embodiments, the hash function may be evaluated for each one of the plurality of nodes at each one of the plurality of nodes to provide a selection output; and may select the receiving node by applying a predetermined criterion to the selection output. An order of transmitting among the plurality of nodes in the neighborhood may be determined using the hash function. The node may be the receiving node and the method may further comprise receiving a transmission concurrently from two or more of the plurality of nodes. The node may not be the receiving node and the method may further comprise determining whether the node has any data queued for transmission to the receiving node and selectively entering a sleep mode when there is no such data. Further, the node may not be the receiving node and the method may further comprise spreading a data transmission to the receiving node by one of spreading over a plurality of time slots and spreading using a CDMA waveform to allow greater reuse of frequencies, thereby reducing an average transmit power for the data transmission. The node may not be the receiving node and the method may further comprise concurrently transmitting data to the receiving node and at least one other node that is not among the plurality of nodes in the neighborhood. The channelized medium may include a multiple access interface channelized according to one or more of time, frequency, and code.

In some embodiments a node for a wireless ad hoc network may include a data source; a radio for operating in the wireless ad hoc network where a plurality of nodes in a neighborhood, that includes the node, share a channelized medium that permits concurrent data communications using two or more channels; and a processor programmed to exchange metadata using the radio with each other one of the plurality of nodes in the neighborhood, thereby providing a common view of the metadata for each one of the plurality of nodes in the neighborhood, the processor further programmed to select one of the plurality of nodes to be a receiving node based upon the metadata and a scheduling algorithm, and the processor further programmed to either transmit data, if any, from the data source to the receiving node when the node is not the receiving node or receiving data from the plurality of nodes when the node is the receiving node. The metadata may include a unique identifier for each one-hop neighbor of each one of the plurality of nodes. The scheduling algorithm may include a hash function, wherein the processor may select the receiving node by applying a unique identifier for the node to the hash function. The processor may further be programmed to evaluate the hash function for each one of the plurality of nodes, at each one of the plurality of nodes, to provide a selection output and the processor may be programmed to select the receiving node by applying a predetermined criterion to the selection output. The processor may be programmed to determine an order of transmitting among the plurality of nodes in the neighborhood using the hash function. The node may be the receiving node and the processor may be further programmed to receive a transmission from the radio concurrently from two or more of the plurality of nodes. The node may not be the receiving node and the processor may be further programmed to determine whether the node has any data queued for transmission to the receiving node and to selectively enter a sleep mode when there is no such data. The node may not be the receiving node and the processor may be further programmed to spread a data transmission from the radio to the receiving node over one of a plurality of time slots and a CDMA waveform to allow greater reuse of frequencies, thereby reducing an average transmit power for the data transmission. The channelized medium may include a multiple access interface channelized according to one or more of time, frequency, and code.

In some embodiments, a method for operating a node in a wireless ad hoc network that may include a plurality of frequency-agile nodes that periodically change operating frequency comprising: receiving a negotiation message from a neighbor at the node in the wireless ad hoc network having a node frequency and a node frequency change precedence indicator (node FCPI), the negotiation message including a new neighbor frequency that identifies a frequency that the neighbor will change to, a countdown indicator that identifies when the neighbor will change to the new neighbor frequency, and a neighbor frequency change precedence indicator (neighbor FCPI) that assigns a precedence to the frequency selected by the neighbor; conditionally updating the node frequency to the new neighbor frequency when the new neighbor frequency is different from the node frequency and the node FCPI is less than the neighbor FCPI, thereby providing an updated node frequency; and changing the node to the updated node frequency. The method of may further comprise updating the node FCPI to equal the greater of the neighbor FCPI and the node FCPI when the new neighbor frequency is the same as the node frequency, thereby providing an updated node FCPI. The method may further comprise transmitting the updated node FCPI to one or more neighbors of the node. The method of claim may further comprising determining whether the new neighbor frequency is acceptable for the node before changing the node to the updated node frequency. The method may further comprise updating the node FCPI to equal the greater of the neighbor FCPI and the node FCPI plus an increment, thereby providing an updated node FCPI. The method may further comprise transmitting the updated node FCPI to one or more neighbors of the node. The wireless ad hoc network may be a dynamic spectrum access network that dynamically allocates spectrum usage according to availability. Changing the node to the updated node frequency may include changing the node concurrently with the neighbor changing to the new neighbor frequency. The method may further comprise controlling a frequency use by the node to avoid a frequency spectrum occupied by a primary network. The primary network may include a cellular telephony network.

In some embodiments, a node in a wireless ad hoc network, which may include a plurality of frequency-agile nodes that periodically change operating frequency, may comprise: a data source; a radio for operating the node within the wireless ad hoc network using a frequency-agile protocol; a memory storing a node frequency and a node frequency change precedence indicator (node FCPI) for the node; and a processor programmed to receiving a negotiation message from a neighbor, the negotiation message including a new neighbor frequency that identifies a frequency that the neighbor will change to, a countdown indicator that identifies when the neighbor will change to the new neighbor frequency, and a neighbor frequency change precedence indicator (neighbor FCPI) that assigns a precedence to the frequency selected by the neighbor, the processor further programmed to conditionally update the node frequency to the new neighbor frequency when the new neighbor frequency is different from the node frequency and the node FCPI is less than the neighbor FCPI, thereby providing an updated node frequency, and the processor further programmed to change the node to the updated node frequency. The processor may be further programmed to update the node FCPI to equal the greater of the neighbor FCPI and the node FCPI when the new neighbor frequency is the same as the node frequency, thereby providing an updated node FCPI. The processor may be further programmed to transmit the updated node FCPI to one or more neighbors of the node using the radio. The processor may be further programmed to determine whether the new neighbor frequency is acceptable for the node before changing the node to the updated node frequency. The processor may be further programmed to update the node FCPI to equal the greater of the neighbor FCPI and the node FCPI plus an increment, thereby providing an updated node FCPI. The processor may be further programmed to transmit the updated node FCPI to one or more neighbors of the node using the radio. The wireless ad hoc network may be a dynamic spectrum access network that dynamically allocates spectrum usage according to availability. The processor may be programmed to change the node to the updated node frequency concurrently with the neighbor changing to the new neighbor frequency. The processor may be programmed to control a frequency use by the node to avoid a frequency spectrum occupied by a primary network. The primary network may include a cellular telephony network.

In some embodiments, a method for operating a node in a wireless ad hoc network, that includes a plurality of nodes capable of changing an operating frequency and a power level, may comprise: identifying a sense duration during which each one of the plurality of nodes is silent; sensing a frequency spectrum during the sense duration; determining an available spectrum based upon radio frequency energy within the frequency spectrum; selecting a transmit power and a transmit frequency for the node based on the available spectrum; transmitting data from the node to one or more other ones of the plurality of nodes using the transmit power and the transmit frequency; and selecting a sense interval, to determine when a next sense duration occurs, based upon a function of the available spectrum and one or more characteristics of the wireless ad hoc network. The plurality of nodes may consist of the node and a one-hop neighborhood of other nodes. The method may further comprise defining a length for the sense duration and communicating the length for the sense duration to the plurality of nodes. The method may further comprise defining a length for the sense interval and communicating the length for the sense interval to the plurality of nodes. The node may be a master node and the method may further comprise communicating the transmit power and the transmit frequency to one or more other ones of the plurality of nodes. Selecting the transmit power and the transmit frequency may include controlling interference by the node with one or more other wireless networks. The one or more other networks may include a frequency-agile network. The one or more other networks may include a cellular telephony network. Identifying the sense duration and sensing the frequency spectrum may be performed outside the plurality of nodes and communicated to the node through one or more of a wired or wireless connection. Selecting the sense interval may include tuning an aggressiveness of the node by controlling a frequency of occurrence of the sense duration.

In some embodiments, a node in a wireless ad hoc network, that includes a plurality of nodes that change operating frequency and power level, may comprise: a data source; a radio for operating the node within the wireless ad hoc network; a memory storing a transmit power and a transmit frequency for the node; and a processor programmed to identify a sense duration during which each one of the plurality of nodes is silent, sense a frequency spectrum during the sense interval, determine an available spectrum based upon radio frequency energy within the frequency spectrum, select the transmit power and the transmit frequency for the node based on the available spectrum, store the transmit power and the transmit frequency in the memory, transmit data from the data source to one or more other ones of the plurality of nodes using the transmit power and the transmit frequency, and select a sense interval, to determine when a next sense duration occurs, based upon a function of the available spectrum and one or more characteristics of the wireless ad hoc network. The plurality of nodes may consist of the node and a one-hop neighborhood of other nodes. The processor may be further programmed to define a length for the sense duration and communicating the length for the sense duration to the plurality of nodes. The processor may be further programmed to define a length for the sense interval and communicating the length for the sense interval to the plurality of nodes. The node may be a master node and the processor further programmed to communicate the transmit power and the transmit frequency to one or more other ones of the plurality of nodes. Selecting the transmit power and the transmit frequency may include controlling interference by the node with one or more other wireless networks. The one or more other networks may include a frequency-agile network. The one or more other networks may include a cellular telephony network. The processor may be programmed to identify the sense duration and sense the frequency spectrum by receiving data concerning the sense duration and the frequency spectrum from a remote source through one or more of a wired or wireless connection. The processor may be programmed to tune an aggressiveness of the node by controlling a frequency of occurrence of the sense duration.

Various features, aspects, and advantages of various embodiments will become more apparent from the following further description.

### BRIEF DESCRIPTION OF THE DRAWINGS

The invention and the following detailed description of certain embodiments thereof may be understood by reference to the following figures wherein:

FIG. 1 is a block diagram of a Mobile Ad Hoc Network (MANET).

FIG. 2 shows a MANET Wireless Protocol that may be used by devices within a MANET.

FIG. 3 is a block diagram of a node in a wireless ad hoc network.

FIG. 4 is a flowchart of a method for implementing receiver-activated multiple access on a node in a network.

FIG. 5 illustrates a neighborhood of nodes using receiver-activated multiple access.

FIG. 6 illustrates a network including multiple transmit and receive nodes.

FIG. 7 shows the spatial footprints for a number of nodes in a network.

FIG. 8 shows the spectral footprint of the three nodes shown in FIG. 7.

FIG. 9 is a flow chart of a method for reducing a spectral footprint for a plurality of frequency-agile nodes in a network.

FIG. 10 shows a use of spectral footprints for a DySAN network and a neighboring primary network user.

FIG. 11 illustrates interference based on transmit power for nodes.

FIG. 12 shows a node transmitting at a high power level.

FIG. 13 shows a node that is transmitting at a normal or medium power level.

FIG. 14 illustrates timing for spectral energy sensing.

FIG. 15 shows the use of release and reconsideration intervals for tunable aggressiveness in a shared spectrum.

FIG. 16 shows a method for controlling spectrum usage by a node in a wireless network.

### DETAILED DESCRIPTION

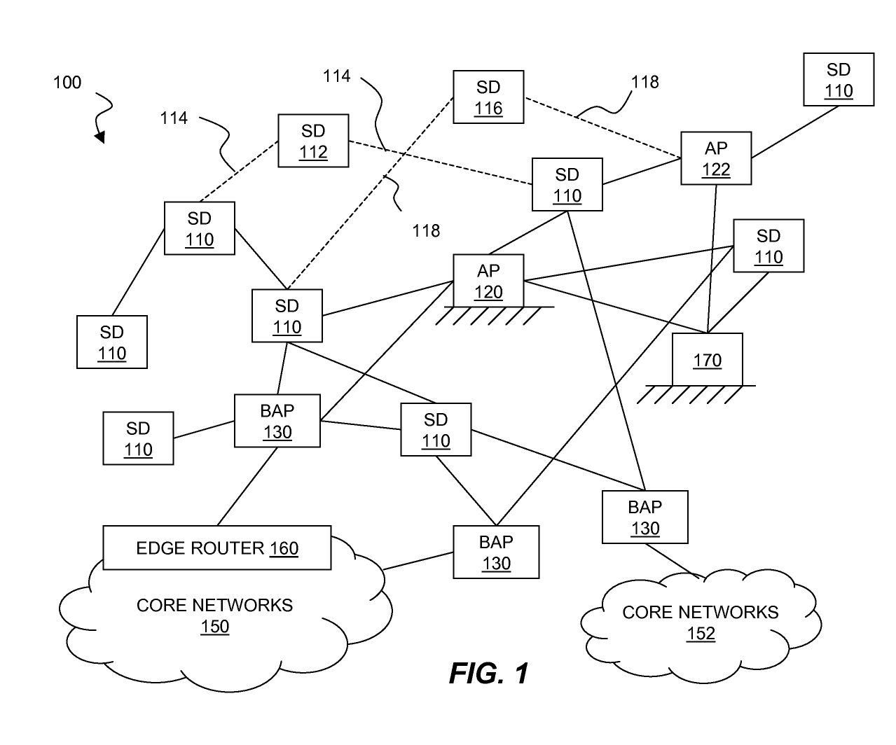

FIG. 1 shows a Mobile Ad Hoc Network (MANET) that may be used with the systems and methods described herein. In general, a MANET 100 (also referred to generally herein as a network 100) may include subscriber devices 110, access points 120, and backhaul access points 130 (for coupling to a core network 150 such as the Internet), all generally interconnected to one another as shown for example in FIG. 1. Without limiting the generality of the foregoing, one or more of the subscriber devices 110 may be a stationary device 170 that does not geographically move within the MANET 100. It will be understood that the device-to-device links illustrated in FIG. 1 are for purposes of illustration only, and in no way are intended to limit the nature or number of links between devices in the MANET 100, which may be created, removed, and/or modified over time according to any corresponding protocols followed by the devices within the MANET 100. In general, the links among devices or components within the MANET 100 are wireless links, although wired links may optionally be employed in various locations such as between the backhaul access point 130 and the core networks 150. In order to maintain the MANET 100, typically one or more protocols are shared among the participating devices to control creation, removal, and modification of individual data links between devices, and to route traffic and control information among the devices. The term protocol as used herein generally refers to any and all such rules, procedures, and/or algorithms used in maintaining the MANET 100, unless a specific protocol is explicitly stated or otherwise clear from the context.

Subscriber devices 110 may include any general purpose nodes participating in the MANET 100 according to suitable protocols. Subscriber devices 110 may, for example, include terminal nodes that send or receive data. Subscriber devices 110 may also or instead suitably be employed as intermediate nodes to route traffic to and from other subscriber devices 110. Thus an ad hoc network as described herein is generally extensible, and as new subscriber devices 110 appear within the MANET 100, they may form a part of the MANET 100 fabric that routes traffic among other nodes. A new subscriber device 112 may be introduced to the MANET 100 with new links 114 being added as the new subscriber device 112 is detected. Devices may also periodically leave the MANET 100 such as a departing subscriber device 116. As the departing subscriber device 116 leaves the network, links 118 between the departing subscriber device 116 and other subscriber devices 110, access points 122, stationary devices 170, backhaul access points 130, and/or other devices may be severed. This may occur, for example when a device moves beyond geographical boundaries of the MANET 100, when devices in the MANET are turned off (or their wireless or networking capabilities are suspended), or when a hardware or software malfunction occurs. The MANET 100 may in a centralized or distributed manner detect new and/or departing devices and/or links in order to maintain substantially continuous connectivity for devices in the MANET 100.

In general, a subscriber device 110 may include any network or computing device that includes a wireless interface, network protocol stack(s), and the like adapted to participate in the MANET 100. The Internet Protocol may usefully be employed in subscriber devices 110 within the MANET 100 in order to use well-established addressing schemes and the like. A subscriber device 110 may include without limitation a cellular phone, personal digital assistant, wireless electronic mail client, laptop computer, palmtop computer, desktop computer, video device, digital camera, electrical instrument, sensor, detector, display, media player, navigation device, smart phone, wireless networking card, wireless router (e.g., for a local WiFi network), storage device, printer, or any other device that might usefully participate in a network. In some embodiments subscriber devices may include a GPS receiver providing a position and timing reference. In embodiments, each subscriber device 110 may be authenticated and/or authorized before being granted access to the MANET 100.

Access points 120 may be provided to establish a permanent or otherwise generally stable infrastructure to the MANET 100. An access point 120 may be fixed in location or may be limited in the amount that it can move. One or more of the access points 120 may be mobile access points 122 that can freely move within the MANET 100. The access points 120 may employ identical network functionality and protocol stacks as the subscriber devices 110 described above. The access points 120 may also or instead encapsulate different functionality consistent with a more specialized role in the MANET 100. In one aspect, the access points 120 may have no associated computing device that originates or consumes network traffic. That is, the access points 120 may simply form a mesh of participants in the MANET 100 and relay traffic among other network participants. An access point 120 may also include a physical connection to a power infrastructure so that it may be physically installed at a location and operate autonomously without requiring regular maintenance for battery changes and the like. In another aspect, access points 120 may include some minimal supplemental circuitry related to, e.g., status and diagnostics, or for receiving software updates and the like. By arranging a spanning network of access points 120 network continuity may be improved in areas where subscriber devices 110 are not present or are not expected to be present with any regularity. In embodiments an access point 120 may be of a size and weight making it suitable for mounting and/or concealment in a variety of locations including indoor and outdoor locations, and including mounting on walls, floors, ground, ceilings, roofs, utility poles, and so forth.

Each access point 120 may include or utilize a timing reference such as any of the Network Timing Protocols described in RFC 778, RFC 891, RFC 956, RFC 958, RFC 1305, RFC 1361, RFC 1769, RFC 2030, and RFC 4330, all published by The Internet Engineering Task Force. Each access point may also, or instead, include a GPS receiver providing a position and timing reference, or any other open or proprietary timing system may be employed.

In embodiments the access points 120 may have a greater transmit power and/or a greater antenna gain than mobile subscriber devices 110, thus providing greater physical coverage than some other devices within the MANET 100.

The MANET 100 may include one or more backhaul access points 130 that generally operate to connect nodes within the MANET 100 to a core network 150 such as the Internet. A core network 150 may be a fixed network or may be an infrastructure network. On one interface, a backhaul access point 130 may have a wireless radio interface, protocol stack(s) and other components of other nodes within the MANET 100. On another interface, the backhaul access point 130 may provide any suitable interface to the core network 150. The backhaul access point 130 may, for example, be deployed at a fiber access point or the like that provides high-speed data capacity for Internet traffic or the like. For example and without limitation, the fiber access point may include a Gig-E router site or an OC-3/12 add-drop multiplexer site. In an embodiment the backhaul access point 130 may include two Gig-E interfaces for backhaul connections. It will be understood that any number and variety of suitable interfaces for backhaul connections may be usefully employed with a backhaul access point 130 as described herein.

A backhaul access point 130 may serve multiple access points 120 within the MANET 100, and may distribute network load across those access points. Alternatively, a single backhaul access point 130 may serve a single access point 120. The number of access points 120 served by a backhaul access point 130 may depend on various factors such as the amount of intra-MANET traffic and extra-MANET traffic, the nature and direction of multicast versus unicast data, and so forth. This association between backhaul access points 130 and access points 120 may change from time to time depending on the presence of other subscriber devices 110 within the area, network conditions, network traffic demands, and so forth. In some cases or under some operating conditions, an access point 120 may be associated with more than one backhaul access point 130.

An edge router 160 may be included between the core network 150 and one or more backhaul access points 130. The edge router 160 may facilitate routing between the MANET 100 and the core networks 150. The core networks 150 may be connected through an edge router 160 to a backhaul access point 130 or may be directly connected to a backhaul access point 130 without going through the edge router 160. More than one edge router 160 may be used to contact multiple backhaul access points 130. In embodiments one edge router may contact multiple backhaul access points 130. The edge router 160 may include any devices or systems for maintaining connectivity between the MANET 100 and the core networks 150, and may further support or enhance network activity within the MANET 100. For example, the edge router 160 may include an industry standard and/or proprietary Address Resolution Protocol server, an application server, a Virtual Private Network server, a Network Address Translation server, a firewall, a Domain Name System server, a Dynamic Host Configuration Protocol server, and/or an Operations, Administration, Maintenance and Provisioning server, and the like, as well as any combination of the foregoing. These various components may be integrated into the edge router 160, or may be provided as separate (physical and/or logical) systems that support operation of the edge router 160. These supporting systems may in general support operations such as broadband Internet connectivity within the MANET 100, broadcast communications crossing between the MANET 100 and the core networks 150, and so forth, as well as the use of multiple backhaul access points 130 to efficiently route inter-MANET (and/or intra-MANET) traffic among subscriber devices 110.

The core networks 150 may include any network resources outside the MANET 100. As shown in FIG. 1, there may be any number of different core networks, which may for example include a second core network 152 connected to the MANET 100 through a backhaul access point 130. The second core network 152 may be wholly independent from the core network 150, or may connect to the core network 150 through a fixed or other type of network. The core networks 150 may connect disparate, geographically remote and/or local instances of the MANET 100 to form a single network. The core networks 150 may include any and all forms of IP networks, including LANs, MANs, WANs, and so on. The core networks 150 may also or instead include the public Internet, the Public Switched Telephone Network, a cellular communications network, or any other network or combination of networks for data traffic, voice traffic, media broadcasting, and so forth. In other embodiments the core networks 150 may consist exclusively of a single zone of administrative control, or a number of zones of administrative control, or some combination of an administrative zone and any of the foregoing.

The stationary device 170 may include any subscriber device 110 that, for whatever reason, does not physically move within the MANET 100. In general, such fixed physical points within the MANET 100 may provide useful routing alternatives for traffic that can be exploited for load balancing, redundancy, and so forth. This may include, for example, a fixed desktop computer within the MANET 100.

Communication within the MANET 100 may be accomplished via protocols, referred to collectively herein as the MANET Wireless Protocol (MWP). In general, any of the nodes above that participate in the MANET 100 according to the MWP may include a hardware platform enabling radio software and firmware upgrades, which may include for example a dedicated or general purpose computing device, memory, digital signal processors, radio-frequency components, an antenna, and any other suitable hardware and/or software suitable for implementing the MWP in participating nodes.

In embodiments, any of the foregoing devices such as one of the access points 120 may also include an adapter for other networks such as an Ethernet network adapter or equivalent IP network adapter, router, and the like, so that non-MANET equipment can participate in the MANET 100 through the device. It will also be appreciated that, while connections to core networks 150, 152 are shown, this connection is optional. A MANET 100 (with or without access points 120) may be maintained independently without connections to any other networks, and may be usefully employed for the sole purpose of trafficking data among subscriber devices 110.

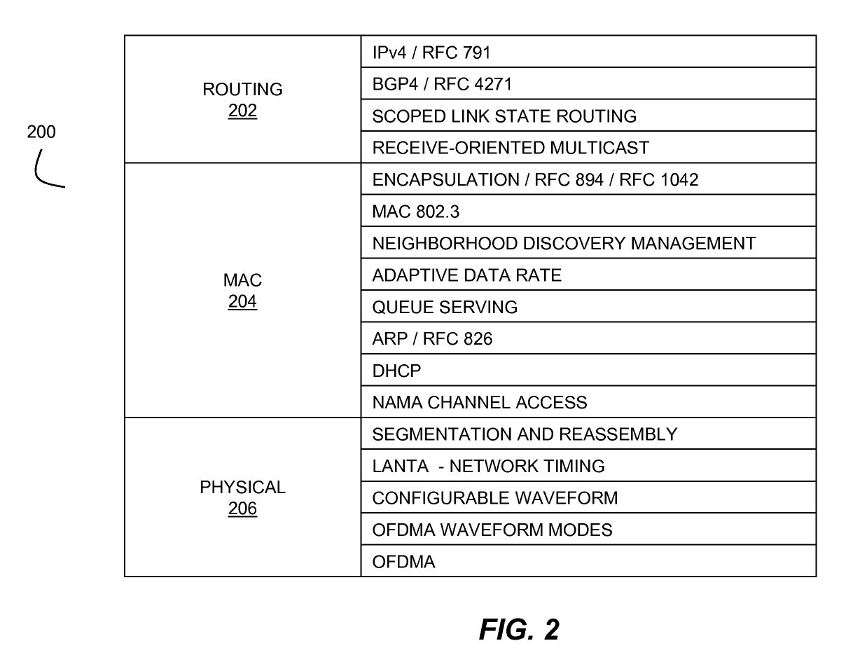

FIG. 2 shows a MANET Wireless Protocol (MWP) stack that may be used by devices within the MANET 100 of FIG. 1.

In general, a protocol stack provides a reference model for communications among network devices so that functions necessary or useful for network communications are available while each functional layer can be designed, modified, and/or deployed free from the implementation details of neighboring layers. Methods and systems disclosed herein may employ any suitable protocol stack to support wireless communications among devices. This may include, for example the Open Systems Interconnection (OSI) Reference Model (with seven layers labelled Application, Presentation, Session, Transport, Network, Data Link (LLC & MAC), and Physical) or the TCP/IP model (with four layers labelled Application, Transport, Internet, Link) along with any adaptations or variations thereof suitable for use in a MANET, or any entirely different computer network protocol design. The lower layer(s) of a protocol stack that support physical interfaces, medium access control, routing and the like may be modified to accommodate mobile ad hoc wireless networking while industry-standard protocols are supported at the routing layer (e.g., for routing at a MANET boundary and/or beyond) and above. In this manner, industry standard applications and devices may be employed within the MANET while using the MANET infrastructure to manage communication. Thus, applications designed for the fixed Internet may be deployed in the MANET, and vice versa, without requiring intervention, such as of a carrier or service provider.

In various embodiments, functions within each layer may be augmented, reduced, or modified on a device-by-device basis. For example, the functionality of each of the layers may be pruned to meet specific requirements without deviating from the scope of the invention. The function(s) of a particular layer may be implemented in software and/or hardware without deviating from the scope of the invention.

As shown in FIG. 2, the layers of a MANET Wireless Protocol (MWP) stack may include a routing layer 202, a medium access control (“MAC”) layer 204, and a physical layer 206. By way of example and not of limitation, each of these layers and the associated functions are now discussed in greater detail.

The routing layer 202 may implement industry standards for routing such as IPv4/RFC 791 and BGP4/RFC 4271. The routing layer 202 may also implement ad hoc wireless networking technologies to replace, e.g., OSPF/RFC 2740 such as scoped link state routing and/or receiver-oriented multicast. This layer may for example support industry-standard unicast and multicast routing protocols at a boundary between a MANET and a fixed network while providing propriety unicast and multicast routing within the MANET.

The MAC layer 204 may implement industry standards for medium access control such as RFC's 894/1042 for encapsulation, MAC 802.3, ARP/RFC 826, and DHCP. The MAC layer 204 may also implement ad hoc wireless networking technologies to replace, e.g., 802.2 LLC and 802.1q such as neighbor discovery management, adaptive data rates, and proprietary queue serving. Similarly, PPP/RFC's 1661/2516 may be substituted with proprietary link scheduling and/or node activated multiple access (NAMA) channel access. The MAC layer 204 may, for example, support quality of service differentiation using channel access and/or queue servicing to prioritize delay-sensitive traffic. In this layer, neighbor management may establish network entry for devices and track changes in each node's local one-hop and two-hop neighborhoods, such as through a message exchange with one-hop neighbors. The MAC layer 204 may support adaptive power control by adjusting transmit power on a link-by-link basis in a MANET in a manner that, e.g., maximizes transmission capacity while minimizing interference according to link conditions and topology. Adaptive data rates may be employed on a link-by-link basis to maximize transmission capacity according to individual link conditions. Queue servicing may provide buffers for data awaiting transmission through a physical layer 206 interface, and may incorporate differentiated quality of service. At the same time, channel access may be used to determine which node transmits in each TDMA time slot, with a schedule influenced by quality-of-service parameters.

The physical layer 206 may implement wireless technologies such as segmentation and reassembly of physical layer transmissions, local area node tracking algorithm (LANTA) network timing, and slot-by-slot configurable waveforms, as well as multiple waveform modes including time domain multiple access and frequency domain multiple access waveforms, or more generally any waveforms that support multiplexing or multiple access based on time, frequency, coding, or the like. In general network timing is also provided within the physical layer 206, and may correct time and frequency errors to ensure that all nodes are operating with a common timebase. At the same time, waveform mode self-discovery may be employed so that each receiver can autonomously discover which waveform mode was sent from a transmitter.

These and other functions and details of operation of a MANET Wireless Protocol stack are described in greater detail for example in U.S. application Ser. No. 12/418,363 filed on Apr. 3, 2009, the entire contents of which are incorporated herein by reference.

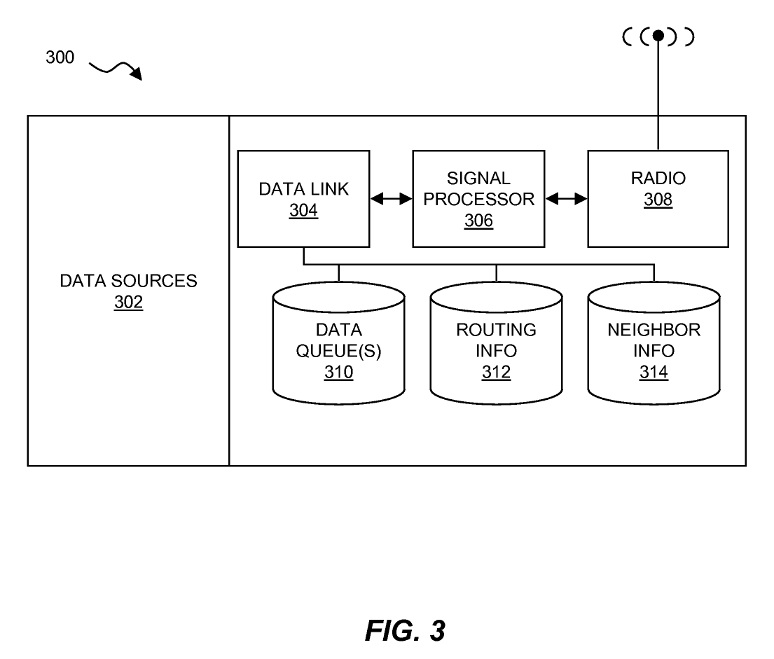

FIG. 3 is a block diagram of a node in a wireless ad hoc network such as the MANET described above. The node may be any of the devices described above, such as a subscriber device, access point, or backhaul access point. In general the node 300 may include data sources 302, a data link 304, a signal processor 306, a radio 308, data queues 310, routing information 312, and neighborhood information 314. It will be understood that the following description is general in nature, and that numerous arrangements of processing, storage, and radio frequency hardware may be suitably employed to similar affect. This description is intended to outline certain operations of a MANET node relevant to the systems and methods described herein, and in no way limits the invention to the specific architecture shown in FIG. 3.

The data sources 302 may include any applications or other hardware and/or software associated with the node 300. This may include, for example, programs running on a laptop or other portable computing device, a web server or client, a multimedia input and/or output sources such as a digital camera or video, and so forth. More generally any device, sensor, detector, or the like that might send or receive data may operate as a data source 302 in the node 300. It will be further understood that some nodes such as access points 104 may not have independent data sources 302, and may function exclusively as MANET 100 network elements that relay data among other nodes and/or provide network stability as generally described above.

The data link 304 may include hardware and/or software implementing data link layer functionality such as neighbor management, segmentation and reassembly of data packets, Quality of Service (QoS) management, data queue servicing, channel access, adaptive data rates, and any other suitable data link functions. In general, the data link 304 controls participation of the data sources 302, and more generally the node 300, in a MANET. It will be understood that the data link 304 in FIG. 3 may implement any number of lower layer (e.g., physical layer) or higher layer (e.g., routing, transport, session, presentation, application) protocols from a conventional Open Systems Interconnection (OSI) Model, or any such protocols and related functions may be implemented elsewhere within the node 300, such as in an IP stack executing on the data source 302, or in firmware within the signal processor 306 or radio 308, or in additional functional blocks not depicted in FIG. 3. For example, routing protocols may be implemented within hardware/software of the data link 304 in order to ensure that nodes in the MANET 100 share appropriate routing functions. Thus it will be appreciated that while the certain elements discussed herein might suitably be placed within the data link layer of a formal protocol stack, the systems and methods of this disclosure might also or instead be implemented with variations to a conventional protocol stack, or without any formal protocol stack whatsoever.

The data link 304 may include a link manager that collects neighbor information from the data link layer, and may form and maintain the neighborhood information 314 for the node 300. This table may be used to establish routes to neighbors, and may be updated periodically with information from one and two hop neighbors as described further below. The link manager may monitor statistics on all active links for a node on a link-by-link basis in order to support link quality calculations and other functions described herein. The term metadata is used herein to generally refer to the neighborhood information 314 for the node 300 or any other information characterized one or more nodes, data links, or other network characteristics that might be shared among nodes to describe the network in which nodes are participating and communicating. In general, the metadata includes at least one item of metadata, although any number of metadata items might be usefully employed according to the number of nodes in a neighborhood and the amount of information to be exchanged among nodes.

The signal processor 306 may include waveform processing and timing functions associated with transceiving data at the node 300. This may include, for example, network timing, time-slot and/or frame-based waveform configuration, maintenance of one or more families of Orthogonal Frequency Division Multiplexing waveform modes (or other transmit mode waveforms), receiver detection of waveform modes, error correction coding, and so forth. In general, the signal processor 306 may be implemented in any suitable combination of digital signal processors, field programmable gate arrays, application-specific integrated circuits, microprocessors, or other general or special-purpose computing devices.

In one embodiment, a family of Orthogonal Frequency Division Multiplexing (OFDM) waveforms may be employed for adaptive data rate communications. The modes of the OFDM waveforms may, for example, include 7.2 MHz Quadrature Phase-Shift Keying (QPSK), 4.8 MHz QPSK, 2.4 MHz QPSK, 1.2 MHz QPSK, 1.2 MHz Binary Phase-Shift Keying (BPSK), or the like. The effective data rate for transmit waveforms may be affected by other parameters such as error correction. In order to facilitate implementation of an adaptive rate system, the transmit modes may be organized into an ordered list of monotonically increasing data rates matched to correspondingly decreasing signal robustness, thus permitting unique mapping of link quality to transmit mode. In one aspect, the actual waveform mode selected to transmit data on a link may be adaptively selected according to any suitable evaluation of link quality for links to neighboring nodes.

The radio 308 in general operates to transmit data from the data queue(s) 310, as organized and encoded by the data link 304 and the signal processor 306 (along with any control information, packet header information, and so forth), over a wireless air interface to other nodes in a MANET, and to perform complementary data reception. The radio 308 may include any radio frequency analog circuitry and the like, and may be coupled to the signal processor 306 which converts data and control information between a digital representation used within the node 300, and an analog representation used in radio frequency communications with other nodes. In embodiments, a low power radio 308 may be employed, such as where the node 300 is a battery-powered mobile device. In other embodiments, a high-power radio 308 may be employed, such as where the node 300 is an access point or backhaul access point connected to a fixed power infrastructure. In an embodiment, the radio 308 and signal processor 306 provide adaptive data rate coding capable of changing transmit modes, error correction, and the like according to measured link quality.

The data queue(s) 310 may include any data for transmission from the node 300. This may include, for example, data from the data sources 302, data that is relayed by the node 300 from other nodes in the MANET, and/or control information scheduled for transmission within data packets from the node 300. The data queue(s) 310 may be organized in any suitable fashion, and may include a single first-in-first-out queue, multiple queues, prioritized queues, and the like. In one embodiment, the node 300 may include multiple prioritized queues to assist in providing various service levels, such as for QoS traffic. In general, data in the data queue(s) 310 is delivered according to any suitable queuing mechanism to the data link 304, signal processor 306, and radio 308 for transmission within the MANET.

Routing information 312 such as a routing or forwarding table may be provided to support routing functions by the node 300. In general, this may include, for example, a destination address or identifier, a cost of a path to the destination (using any suitably cost calculation), and a next hop on that path. Other information such as quality of service and other metrics for various routes and links may also be provided for more refined routing decisions.

Neighborhood information 314 may be maintained in a database, flat file, routing table, or other suitably organized volatile or non-volatile storage within the node 300. The neighborhood information 314 generally supports the creation and maintenance of the MANET as well as routing functions of each MANET node. Within the MANET, each node may interact with other nodes to autonomously identify and maintain local network connections, shift capacity, dynamically form routes throughout the network, and so on. The routing functions of the node (as supported by the neighbourhood information 314) may accommodate delay-sensitive (e.g. voice) traffic, delay-tolerant traffic with quality of service (QoS) prioritization, and so on.

The neighborhood information 314 may include an identification of neighboring nodes along with information relating to those nodes. This may include one-hop neighbors (i.e., neighboring nodes in direct wireless communication with the node 300), two-hop neighbors (i.e., neighboring nodes that communicate with the node 300 through only one other node), or any other nodes or participants within the MANET. In one aspect, neighborhood information 314 includes link quality information for the radio 308, which may be obtained from any combination of physical layer and data link data, and may be employed to adapt the data rate of communications according to currently present channel conditions. The neighborhood information may also include QoS data used to select next hops for QoS data. Other useful information may include bandwidth utilization, node weights, node position (either logical or physical), and queue latency for each QoS type and/or other priority type.

In one aspect, the neighborhood information 314 may be gathered during periodic exchanges (such as during control transmissions) with neighboring nodes, which may occur under control of the link manager of the data link 304. For example, the node 300 may determine output bandwidth (i.e., data transmit requirements) for each link that the node 300 has with a neighbor, and may transmit this to one-hop neighbors. Similarly, the node 300 may receive output bandwidth from each one-hop neighbor. Using this data, each node 300 may further calculate its own input bandwidth (i.e., data receive requirements) from each link to a neighboring node, and this information may in turn be exchanged with one-hop neighbors. Following a system-wide exchange with one-hop neighbors, the node 300 (and every other node in the MANET) may calculate a node weight that represents relative output requirements for the node 300. For example, the node weight, W, may be calculated as:

$$W = \frac{{BW}_{out}}{{BW}_{out} + {BW}_{in}} \qquad [ Eq . 1 ]$$

where BWₒᵤₜ is the total output or transmit requirements for each link of the node 300, and BWᵢₙ is the total input or receive requirements for each link of the node 300. Finally, the node 300 may transmit the node weight to each neighboring node, and may in turn receive a node weight from each neighboring node. It will be appreciated that the node weight, W, may be further processed for use with other neighborhood information 314, such as by limiting the value according to the number of bits used for control information, or by providing a supplemental adjustment to the node weight to further refine control of routing or other MANET functions. Sharing of information for maintenance of the neighborhood information 314 may be controlled, for example, by the data link 304, which may apply any suitable technique to determine when to share information with one hop neighbors. In one aspect, the data link 304 may transmit data whenever a change is detected in the MANET such as an addition or deletion of a node.

As noted above, any of the neighborhood information 314, routing information 312, and/or data queue(s) 310, as well as status or other information concerning any of the foregoing, may usefully be shared among the nodes participating in a network, and all such information is intended to fall within the meaning of metadata as that term is used herein.

In another aspect, for a MANET that has location-aware nodes 300 (e.g., using Global Positioning System (GPS) data, signal strength data, and so forth), the neighborhood information 314 may include position data in order to support location-based routing and the like.

Having described a MANET in general terms, the description now turns to a more detailed treatment of receiver-activated multiple access (“RAMA”) techniques for allocating communications opportunities in a MANET or similar network.

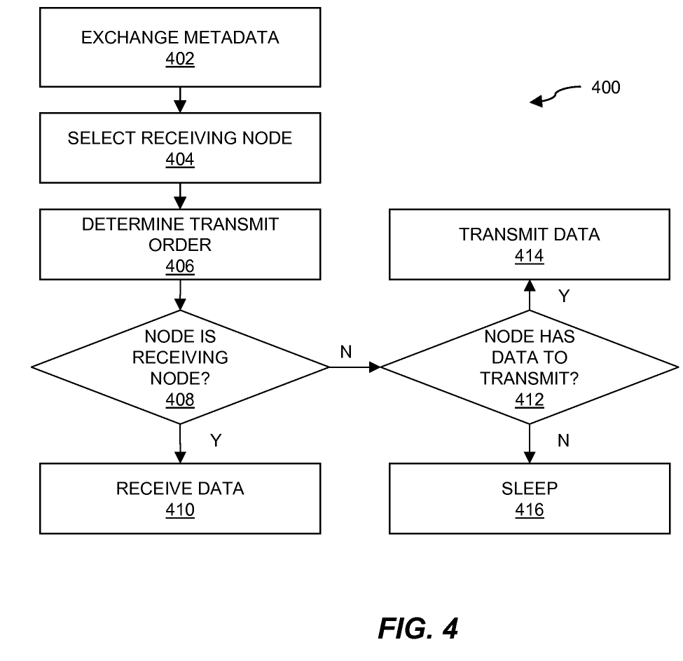

FIG. 4 shows a method for implementing receiver-activated multiple access on a node in a network. In general, the network may be a MANET as described above, or any other wireless or wired network that includes a number of nodes in a neighborhood sharing a channelized medium that permits concurrent data communications over two or more channels.

Numerous techniques for channelizing a medium such as an air interface are known in the art and may be adapted to use with the method described below. For example, the channelized medium may include a multiple access interface channelized according to one or more of time, frequency, and code. The medium may also, or instead be channelized using different transmit modes (e.g., sixteen symbol quadrature amplitude modulation, sixty-four symbol quadrature amplitude modulation, etc.), or more generally using any static, dynamic, adaptive, or other techniques to provide multiple concurrent communication channels. In the following discussion, it should be understood that time domain multiplexing, while nominally dividing a carrier into discrete time slots for communication, is considered a channelized medium as that term is used herein, and generally permits any combination, division, subdivision, or other use of time slots consistent with this disclosure. It should be appreciated that in principle, the same techniques described below may be adapted for use in networks that do not permit concurrent data communications over two or more channels, however use of the method described below with concurrent communication capabilities advantageously permits a designated receiving node to receive communications concurrently from a number of different transmit nodes at the same time.

As shown in step 402, the method 400 may begin with exchanging metadata with each other one of a plurality of nodes in a neighborhood. In general, this exchange of metadata provides a common view of the metadata for each one of the plurality of nodes in the neighborhood, which permits scheduling of data communications, as well as other synchronized operations among the nodes. The metadata may, for example, include a unique identifier for each one-hop neighbor of each node in the plurality of nodes. The metadata may also or instead include link quality data for a data link between two or more of the plurality of nodes. More generally, the metadata may include any information useful for selecting a single, unique receiving node or related functions such as control of spectral footprint, power footprint, and so forth within the neighborhood, and more generally within the network.

As shown in step 404, the method 400 may include selecting a single one of the plurality of nodes to be a receiving node based upon the metadata. Each one of the plurality of nodes participating in this selection (e.g., the nodes in the neighborhood) may apply the common view of the metadata obtained during the exchange described above, along with a common scheduling function known to all of the nodes to select the same receiving node. A variety of techniques may be employed for this purpose. For example, the common scheduling function may include a hash function, and the selection of a single receiving node may be made by having each node (including the present node) apply its own unique identifier, such as an identification number, to the hash function. Additional data such as some or all of the metadata described above may also (or instead) be applied to the hash function, provided each node applies the same metadata and can obtain the same results.

It will be appreciated that introducing some data in addition to the unique identifiers of each node permits a random, or pseudo-random, selection of a receiving node, as well as the priority and/or order of transmit nodes as discussed below. Thus the method 400 in general, or the step of selecting a receiving node 404 in particular, may include evaluating a hash function for each one of the plurality of nodes at each one of the plurality of nodes to provide calculated results referred to herein as a selection output. Numerous hash functions are usable for these purposes, including for example STL. In this manner, each one of the nodes evaluates the selection algorithm (e.g., using the hash function) for itself and for every other node in the neighborhood so that each node can reach a common determination of the receiving node. By way of example, if there are four nodes in a neighborhood, each of the four nodes can perform four different evaluations including one evaluation for itself and one for each of its three neighbors. The results, i.e., the selection output, may then be further evaluated to identify the receiving node which may, for example, be the node with the highest selection output value, the node with the lowest selection output value, or the node for which the selection output meets some other predetermined criterion or group of criteria. As another example, each node may evaluate the hash function with a common view of the metadata, and each node may obtain its own selection output value using a subset of bits in the hash function output, based on, e.g., the node's unique identifier number. Thus for example, the node with the lowest unique identifier may obtain a value (for purposes of selecting a receiving node) that is the four least significant bits in the hash output. The node with the second lowest unique identifier may obtain a value that is the next four least significant bits, or optionally the second through fifth least significant bits. More generally, it should be understood that a wide variety of selection techniques are possible, and that the preceding examples are not intended to limit the scope of this disclosure in this respect.

In general, the use of metadata such as queue size, link quality, and the like will result in a random or pseudo-random selection of a receive node as the network changes over time. However, it will be appreciated that the common scheduling algorithm and/or selection output may be further refined if appropriate, such as to de-prioritize a node or group of nodes that have recently acted as the receiving node, or by prioritizing a node when another node has a large amount of corresponding transmit data in its queue. All such variations as would be apparent to one of ordinary skill in the art may be suitably adapted to use for the selection of a receiving node as described herein.

As shown in step 406, the method 400 may include determining a transmit order for any of the nodes that are not the receiving node. An order of transmitting among the plurality of nodes in the neighborhood may be determined for example using the hash function described above. Using the same techniques as described above to select a receiving node, e.g., applying shared metadata and each node's unique identifier to a common scheduling algorithm, each node may obtain a unique output value in the selection output. These results may be used, e.g. with numerical sorting or any other suitable technique shared among the nodes to determine a transmit order in which the nodes transmit to the receiving node. Where the air interface is channelized to permit concurrent data transmission on two or more channels, multiple nodes may advantageously be scheduled to transmit concurrently using the multiple channels.

As shown in step 408, the method 400 may include determining when the present node (i.e., the node performing the method 400) is the receiving node. If the present node is the receiving node, then the method 400 may continue to step 410. If the present node is not the receiving node, then the method 400 may continue to step 412.

As shown in step 410, the method 400 may include receiving data from the plurality of nodes when the node is the receiving node. As noted above, this may include receiving a transmission from two or more nodes concurrently where the air interface is suitably channelized. This may also or instead include serially receiving transmissions from one or more other nodes according to a schedule determined in step 406 above. The received data may be used by the node (where the node is a destination for the data) or queued for retransmission to a destination node or another intermediate node in the network.

As shown in step 412, the method 400 may include (when the node is not the receiving node) determining whether the node has any data queued for transmission to the receiving node. In general, this may include an evaluation of data queues or other data structures, buffers, or the like used to schedule data for transmission from the node. The data may include data sourced from the node, or other data received by the node for re-transmission to one or more other nodes in the network. If the node has data to transmit, the method 400 may proceed to step 414. If the node does not have any data to transmit, the method 400 may proceed to step 416.

As shown in step 414, the method 400 may include transmitting data, if any, to the receiving node when the node is not the receiving node. This may be, for example, according to a schedule shared with other nodes in the neighborhood according to a scheduling algorithm or the like as described above in step 406. This may include spreading a data transmission to the receiving node over a plurality of time slots in order to reduce an average transmit power for the data transmission. Alternatively, spreading may be accomplished by using a Code Division Multiple Access (CDMA) waveform to allow greater reuse of frequencies, even if this may cause lower channel efficiency by reducing the interference to communications range ratio. Thus a data transmission may be advantageously adapted to conserve power or to reduce the power or spectral footprint of a node in the network.

In one aspect where the air interface is channelized, the node may transmit data to the receiving node and one or more other nodes in the network. As generally described herein, a single, unique node is designated as a receiving node in a neighborhood. In a network larger than the neighborhood, a node may also belong to any number of different one-hop (and/or two-hop) neighborhoods, each of which may independently (or, with adaptations, cooperatively) apply the receive-activated techniques described herein. In such an environment, a node may concurrently transmit to two or more different receiving nodes in two or more different neighborhoods, subject to certain scheduling limitations such as an inability to transmit different data in the same channel at the same time. Thus the method 400 may include concurrently transmitting data to the receiving node and at least one other node that is not among the plurality of nodes in the neighborhood.

As shown in step 416, the method 400 may include selectively entering a sleep mode when there is no data queued for transmission to the receiving node. This may include turning off the radio or components thereof, or otherwise pausing, suspending, sleeping, or terminating network operations of the node until the next opportunity to send or receive data. The manner in which a sleep mode is implemented may be adapted to conserve energy, power footprint, or the like for the node and/or the network, and may advantageously be employed, for example, to preserve battery life of the node or to reduce interference with other communications.

It will be understood that the method 400 described above is set forth by way of example and not of limitation. Numerous variations, additions, omissions, and other modifications will be apparent to one of ordinary skill in the art. In addition, the order of presentation of these steps in the description and drawings is not intended to require this order of performing the recited steps unless a particular order is expressly required or otherwise clear from the context. For example, the order in which transmit nodes send data to the receiving node may be determined after or before a node determines whether it is the receiving node, or an exchange of metadata may occur concurrently with other scheduling functions, such as using a control signal time slot or channel in a communications protocol. As another example, the method 400 may always return to step 402 where metadata is exchanged, or the method 400 may return to step 404 some number of times and repeat transmissions to a particular receive node either deterministically (e.g., four times) or according to some criterion (e.g., depth of a node's queue for transmission to the receiving node) before a new exchange of metadata. It will also be understood that the method 400 may be executing concurrently on any number of nodes within a network, and that the method 400 may execute repetitively and/or as any number of separate execution threads on a single node. All such variations are intended to fall within the scope of this disclosure.

In addition, the method 400 may be embodied in a device including, e.g., a radio and a data source as described above, as well as a processor (which may be any of the programmable device(s) described herein) programmed to perform any or all of the steps described above. In addition, the method 400 may be embodied in computer programmable code that when executing on one or more computing devices performs the recited steps. Thus the foregoing description is not limiting, and should be interpreted broadly to include all embodiments of the subject matter allowable by law.

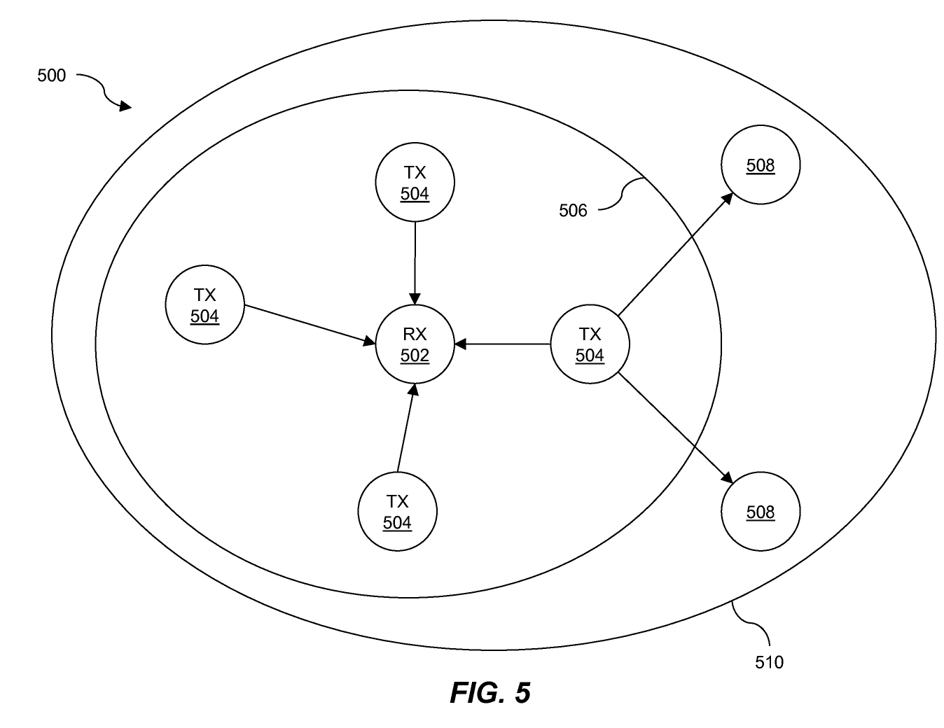

FIG. 5 illustrates a neighborhood of nodes using receiver-activated multiple access. A network 500 may include a receiving node 502 and a number of transmit nodes 504 in a one-hop neighborhood 506 of the receiving node 502, as well as a number of additional nodes 508 in a two-hop neighborhood 510 of the receiving node 502. Each of the nodes in FIG. 5 may be, for example, any of the nodes described above.

The one-hop neighborhood 506 of the receiving node 502 includes those nodes in the network 500 that are in direct communication with the receiving node 502 so that signals from one of the one-hop neighbors (e.g., the transmit nodes 504) can transmit a signal from its radio to the radio of the receiving node 502. The receiving node 502 may be scheduled as the receiving node 502 using any of the techniques described above. During a receive interval, the receiving node 502 may receive data from one or more of the transmit nodes 504, which may transmit serially, concurrently (e.g., using different channels), or some combination of these.

The two-hop neighborhood 510 of the receiving node 502 further includes nodes 508 that can be reached with one additional hop, such as through one of the transmit nodes 504 in the one-hop neighborhood 506. In general, during an exchange of metadata or the like, each node transmits information about its one-hop neighborhood to each of its one hop neighbors. As a result, each node in the network 500 can obtain a view of its two-hop neighborhood 510, and each node in the one-hop neighborhood 506 can obtain a consistent view of the one-hop neighborhood of the receiving node 502. It will be understood that other neighborhoods and message exchanges may usefully be employed to obtain other metadata and network views. However, the exchange of metadata with one hop neighbors provides a useful view of an immediate neighborhood of nodes that can be employed for routing, traffic management, and so forth. As noted above, in certain embodiments, one of the transmit nodes 504 may also operate concurrently as a transmit node in another, different one-hop neighborhood for another receiving node.

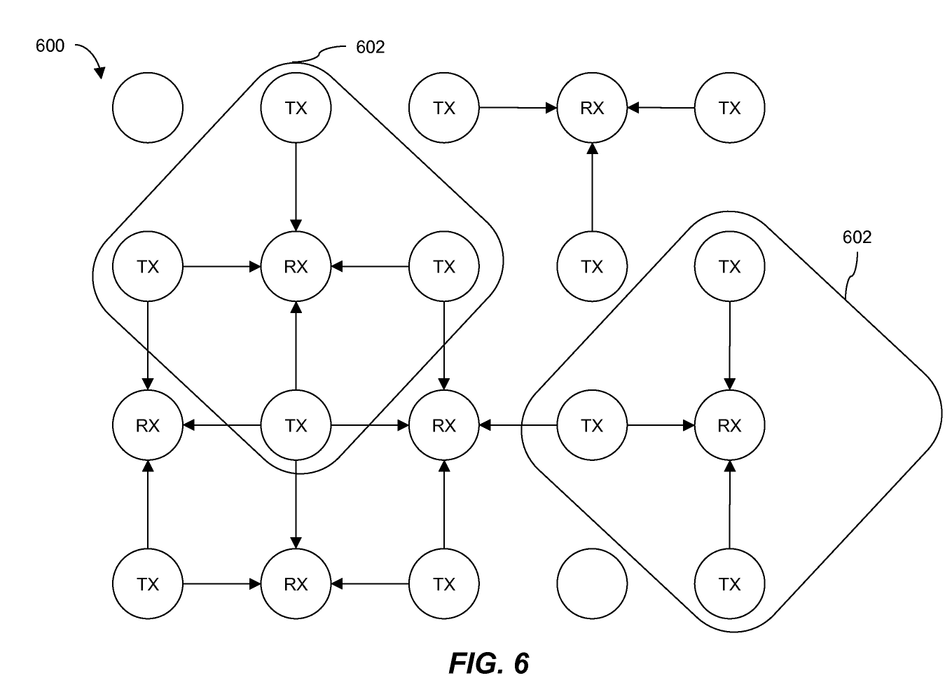

FIG. 6 illustrates a network including multiple transmit and receive nodes. A network 600 may allocate receive nodes as generally described above. In general, the receiving nodes (labeled “RX”), may be any combination of nodes within the network 600. It will also be noted that in general, no one-hop neighborhood 602 contains more than one receiving node, although a transmit node (labeled “TX”) may concurrently transmit to more than one receiving node, such as by using the techniques described above. Although not illustrated, it is also possible to have separate overlying networks (e.g., using different frequency carriers, different radio hardware, and so forth) in which case one-hop neighbors may be receiving nodes on different networks, or a particular node may be a receiving node in one network and a transmit node in another network. More generally, a variety of topologies may be employed using different channels within an air interface, different air interfaces, or some combination of these. All such variations as would be apparent to one or ordinary skill in the art are intended to fall within the scope of this disclosure.

In one aspect, the network described herein may be a dynamic spectrum access network (DySAN). In general, a dynamic spectrum access network allocates spectrum usage according to availability, which may depend, for example, upon interference, link quality, other primary users, or any other factors affecting radio links among nodes. The dynamic spectrum access network (DySAN) may use frequency-agile nodes with a radio and accompanying processor or the like capable of independently selecting and changing among a number of operating frequencies. As described herein, a reduced spectral footprint may be achieved by coordinating the selected operating frequencies for a number of transmitters across the network. In order to converge to a smaller spectral footprint, nodes may exchange negotiation messages containing any useful metadata such as their selected operating frequency, an optional backup operational frequency, a frequency change precedence indicator (FCPI), and an indication of whether they are currently executing a countdown to change their operating frequency.

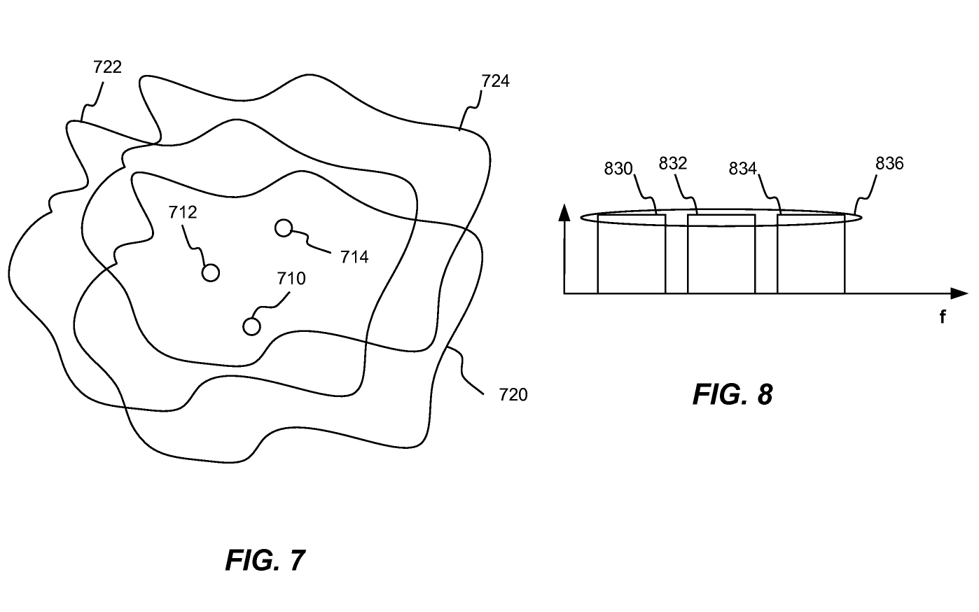

FIG. 7 shows the spectral and spatial footprints for a number of nodes in a network. In general, when a node transmits, it has the potential to create interference in a geographic region over the occupied radio frequency. The terms spatial footprint and spectral footprint are used herein to describe the different operating regions for a node in geographic space and frequency space respectively. When multiple network nodes in a common geographic region take turns transmitting on different frequencies, each creates its own spatial footprint on its own operating frequency. While a footprint may in general have any shape, and may have a substantially elliptical or circular shape under ideal conditions, an actual footprint will generally have an irregular boundary as illustrated in the figure due to physical obstructions and the like.

In general, a first node 710 may have a first spatial footprint 720 which encloses the geographic extent of interference with other radio frequency activity. A second node 712 may have a second spatial footprint 722 which encloses the geographic extent of interference by the second node 712. A third node 714 may have a third spatial footprint 724 which encloses the geographic extent of interference by the third node 714. The overall spatial footprint for the geographic extent of interference of the nodes 710, 712, and 714 is the union of these shapes 720, 722, and 724 combined.

FIG. 8 shows the spectral footprint of the three nodes shown in FIG. 7. The first node 710 may have a first spectral footprint 830 with a strength and frequency (or frequency range) as illustrated. The second node 712 and the third node 714 may also have a second spectral footprint 832 and a third spectral footprint 834 respectively as illustrated. An aggregated spectral footprint 836 is a combination of the three individual spectral footprints 830, 832, and 834, as illustrated with an oval encompassing the individual spectral components. It will be noted that while the aggregate spatial footprint shown in FIG. 7 has increased slightly, the aggregate spectral footprint has increased dramatically, reducing spectral efficiency. In order to achieve a minimal spectral footprint, the nodes may coordinated to share a single frequency so that the aggregate spatial footprint becomes the outer boundary of the three individual footprints shown in FIG. 7 and the aggregate spectral footprint 836 becomes a single one of the spectral footprints 830, 832, or 834.

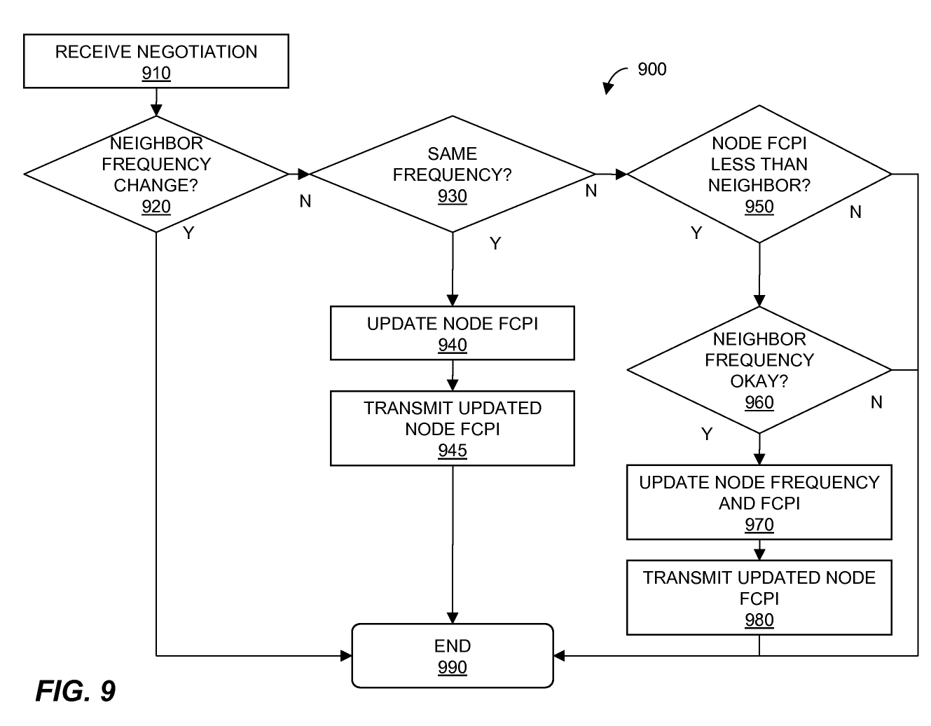

FIG. 9 is a flow chart of a method for reducing a spectral footprint for a plurality of frequency-agile nodes in a network. In general, such nodes may employ frequency changing in order to spread communications over an available spectrum. In order to converge to a minimum spectral footprint, a number of nodes may exchange negotiation messages containing metadata such as selected operating frequencies, a frequency change precedence indicator (FCPI), and an indication of whether they are currently executing a countdown to change their operating frequency. This information and the like may be used to coordinate operation of multiple nodes to reduce an aggregate spectral footprint.

As shown in step 910, the method 900 may begin with receiving a negotiation message at a node from a neighbor, such as any of the one-hop neighbors described above. This message may be transmitted as an ordinary data packet, or as a control or signaling channel packet, or as a packet header with any of the foregoing, or using any other form or format suitable for exchanging messages among nodes. The node may include a memory such as any of the memories described herein that stores existing information for the node, such as a node frequency at which the node is currently operating and a node frequency precedence indicator (node FCPI).

The message may include a countdown indicator. In general, in the absence of spectrum optimization as described herein, a frequency-agile node may periodically change operating frequency, such as according to a fixed, random, or pseudo-random schedule. When this scheduled change occurs, the new frequency may also be selected randomly, pseudo-randomly, or according to a fixed or otherwise predetermined schedule. Thus the countdown indicator may identify when a frequency-agile neighbor will change frequency, and may be used for example to synchronize a frequency change among a number of neighboring nodes. In one aspect, this may be implicit, such as by having the negotiation message transmitted immediately before a neighbor changes its frequency, or at a predetermined time before the neighbor frequency changes. In another aspect, the message may indicate that a countdown to the change has been initiated, or may include a countdown value indicating a number of time units until the neighbor frequency will change. More generally, the negotiation message may provide an indication of if and/or when the neighbor will change a frequency.

The message may include a frequency change precedence indicator (FCPI). In general, the FCPI assigns a precedence to a new neighbor frequency selected by the neighbor. This value may be used as described below to propagate a shared frequency footprint among a number of nodes.

The message may include a new neighbor frequency that identifies a frequency to which the neighbor will switch upon expiration of the countdown. This may include a numerical identifier, a frequency identifier, or any other description or characteristics that can be interpreted by a receiving node to determine the new neighbor frequency and/or other transmission encoding characteristics (such as a mode, a time slot, etc.). It will be appreciated that in this context, a frequency may be a center frequency about which numerous frequency sub-bands can be provided for a frequency-agile node that is nominally operating at the center frequency. In another aspect, the new neighbor frequency (or any of the other frequencies discussed herein, unless explicitly stated to the contrary) may specify a range of available operating frequencies, or a list of discrete frequency sub-bands that together form the new neighbor frequency. In another aspect, the new neighbor frequency may provide an identifier that specifies one of a sequential number of frequency bands, such as by having the identifiers 1, 2, 3, . . . correspond to center frequencies starting at some particular value (e.g., 200 MHz) and progressing upward in fixed increments (e.g., 50 kHz).

The message may include other useful information, such as a backup frequency identifier that specifies a frequency to which the neighbor will switch if the neighbor detects that the new neighbor frequency is degraded, occupied, or otherwise unavailable upon expiration of the countdown.

As shown in step 920, the node may evaluate whether the neighbor is changing a frequency for transmission. If the neighbor is changing frequency, the method 900 may proceed to step 990 and terminate. In this case, no change to the node behavior is made, and the node may transmit one or more negotiation messages, and then change frequency according to any pre-existing schedule or algorithm. In one aspect, the frequency change may be temporally coordinated with other nodes by using a countdown timer or the like to synchronize a simultaneous change by two or more nodes. If the neighbor is not changing frequency, the method 900 may proceed to step 930.

As shown in step 930, when the neighbor is not in the process of changing the frequency for transmission, the node may check to determine whether the node and the neighbor share the same frequency. If the node and the neighbor already share the same frequency, the method 900 may proceed to step 940. If the node and the neighbor do not already share the same frequency, the method 900 may proceed to step 950.

As shown in step 940, when the node and the neighbor share the same frequency (and the neighbor is not about to change frequency), the node may update its own frequency change precedence indicator (FCPI) to equal the larger of either the node FCPI or the neighbor FCPI. The neighbor FCPI may be obtained, for example, from the negotiation message received in step 910, or more generally in an exchange of metadata as described generally above. Thus in one aspect, the method 900 may include conditionally updating the node FCPI to equal the greater of the neighbor FCPI and the node FCPI when the new neighbor frequency is different from the node frequency, thus providing an updated node FCPI.

As shown in step 945, the method 900 may include transmitting the updated FCPI to one or more neighbors of the node, such as in a negotiation message from the node before the node changes its own frequency. The node may subsequently change frequency (to the new neighbor frequency) according to any pre-existing schedule or algorithm. The method 900 may then proceed to step 990 and terminate.

As shown in step 950, when the node and the neighbor are on different frequencies, the node may compare the node FCPI and the neighbor FCPI, such as to evaluate whether the node FCPI is equal to or greater than the neighbor FCPI. Thus the method 900 may include conditionally updating the node frequency to the new neighbor frequency when the new neighbor frequency is different from the node frequency and the node FCPI is less than the neighbor FCPI, thus providing an updated node frequency. The method 900 may then proceed to step 960. On the other hand, if the node FCPI is equal to or greater than the neighbor FCPI, the method 900 may proceed to step 990 and terminate. In this latter case, no change to the node behavior is made, and the node may transmit one or more negotiation messages and change frequency according to any pre-existing schedule or algorithm.

As shown in step 960, the method 900 may include determining whether the new neighbor frequency is acceptable for the node. This may be done before changing the node to the updated node frequency. If the new neighbor frequency is not acceptable for the node, the method 900 may proceed to step 990 and terminate. In this case, no change to the node behavior is made, and the node may transmit one or more negotiation messages and change frequency according to any pre-existing schedule or algorithm.

As shown in step 970, the method 900 may include updating the node frequency to the new neighbor frequency based upon the information in the negotiation message received from the neighbor, thus providing an updated node frequency. The node FCPI may also be updated to reflect the precedence of the updated node frequency, such as by setting the node FCPI to an updated node FCPI equal to the greater of the neighbor FCPI and the node FCPI plus one (or some other suitable increment) to reflect a raised precedence.

As shown in step 980, the method 900 may include transmitting the updated node FCPI to one or more neighboring nodes in a negotiation message from the node. The method may further include changing the node frequency to the updated node frequency according to any pre-existing schedule or algorithm for the node. The method 900 may then proceed to step 990 and terminate.

In general, the method described above permits a common operating frequency to be propagated across nodes in an ad hoc network topology. Numerous variations and adaptations will be readily appreciated. Those of skill in the art will understand for example that the sequence of operations in the method 900 may be modified without departing from the inventive concept. Furthermore a pair of nodes, a group of nodes, or an entire network may coordinate changes in frequency using this approach. A frequency-agile node or network using this approach may avoid interference with neighboring networks or localized interference within a network by affirmatively selecting a frequency at one node and assigning a high precedence indicator thereto.

In other embodiments, precedence indicators may be used to confine frequency-agile nodes to a minimal spectrum, either across a network or within a neighborhood or some other portion of a network, such as by including a neighborhood identifier or the like in each precedence indicator. In some embodiments a preferred frequency may be assigned a precedence so that it is used preferentially across some or all of the network. In other embodiments it may be preferable to have multiple frequencies used within a network or a portion of a network, or to have specific frequencies used in specific portions of the network. In some embodiments it may be preferable for frequencies to be chosen at random within a certain frequency range. Any such combination may be realized with a suitable selection of precedence indicators as described herein.

In other embodiments, by using CDMA in addition to FDMA/TDMA (frequency-division multiple access/time-division multiple access) the interference range may be made equal to the communications range by properly choosing the spreading factor and the number of users allowed in each CDMA channel. The scheduling algorithms may use this additional dimension much like additional frequencies; the number of channels is the product of the number of spreading codes times the number of frequency segments.

Additionally, CDMA may be used advantageously in a DySAN network since links may have additional interference tolerance and thereby ease the required DySAN responsiveness in an operational system. The capacity of the network may be lower than what is achievable with additional information but fortunately less complete information is required for implementation. The capacity at a given node is determined from the Shannon integral of log₂(SNR(w)+1) where the integral is evaluated over the bandwidth given in bits/rad and where the term SNR(w) represents the signal to noise ratio at each frequency. With CDMA the possible capacity is log₂(integral[(SNR(w))/(w+1)]). In other words, the channel capacity is the log₂ of the geometric mean of the SNR and the latter it is the log₂ of the arithmetic mean. These values are identical if the value of SNR(w) is a constant and the latter always has an upper bounded of the former.

It may be noted that using CDMA can be more challenging than in a traditional base station in certain types of application since the timing for the spreading cannot be synchronized across the entire network with the same degree of precision. For this reason the spreading codes may not be made completely orthogonal as normally assumed and only orthogonal in a statistical sense. These factors degrade the performance gained by using CDMA but nonetheless the use still has merit in a MANET network.

It will be understood that the method 900 described above for reducing or controlling spectrum usage by frequency-agile nodes is set forth by way of example and not of limitation. Numerous variations, additions, omissions, and other modifications will be apparent to one of ordinary skill in the art. In addition, the order of presentation of these steps in the description and drawings is not intended to require this order of performing the recited steps unless a particular order is expressly required or otherwise clear from the context. All such variations are intended to fall within the scope of this disclosure. In addition, the method 900 may be embodied in a device including, e.g., a radio and a data source as described above, as well as a processor (which may be any of the programmable device(s) described herein) programmed to perform any or all of the steps described above. In addition, the method 1600 may be embodied in computer programmable code that when executing on one or more computing devices performs the recited steps. Thus the foregoing description is not limiting, and should be interpreted broadly to include all suitable variations, as well as all embodiments of the subject matter allowable by law.

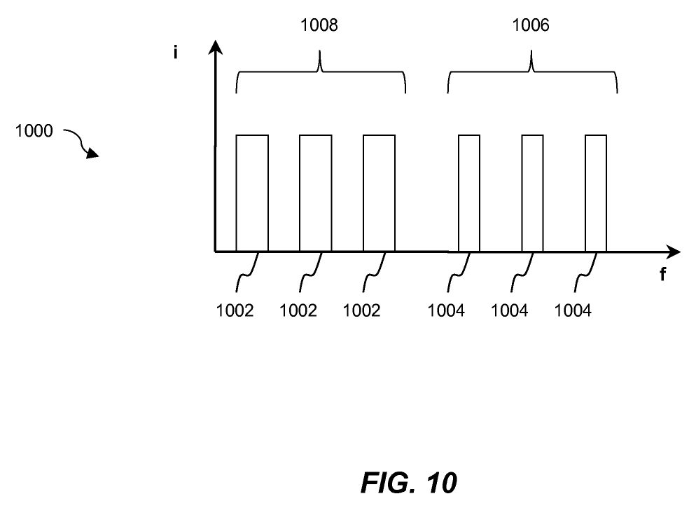

FIG. 10 shows a use of spectral footprints for a DySAN network and a neighboring primary network user. In embodiments, the DySAN may be deployed in an area with a pre-existing, primary network user such as a telecommunications carrier, cellular network operator, or the like. The DySAN network needs to avoid causing interference to nodes of the primary network in their occupied frequencies, particularly where these frequencies are licensed or otherwise regulated. As illustrated, a primary network such as a cellular telephony network, a WiMax network, or any other wireless network may occupy one or more frequency bands 1002 within a spectrum 1000. The DySAN network may have radio capabilities spanning the full spectrum 1000 (or any portion thereof), but may be usefully limited (using the techniques described above) to a second group of frequency bands 1004 with a spectral footprint 1006 separated from the primary user spectral footprint 1008. When the DySAN nodes are uncoordinated, each one may only obtain a small portion of the available spectrum 1000. However, by coordinating the DySAN nodes to select a common operating frequency, the DySAN nodes secure a larger contiguous spectrum that avoids one or more primary users.

When two or more DySAN networks occupy a common geographic area and frequency band, they may similarly coordinate between themselves to determine spectrum assignments. This coordination can occur over a wired or wireless connection between the multiple networks, and may use any of the techniques discussed above to allocate each DySAN network to a minimal spectral footprint consistent with its bandwidth requirements, latency requirements, or any other network requirements. More generally, the techniques described above may be employed to minimize an aggregate selection of operating frequencies for nodes in a DySAN, maximizing an available bandwidth not used by nodes in a DySAN, or otherwise controlling or limiting frequency use by nodes in a DySAN.

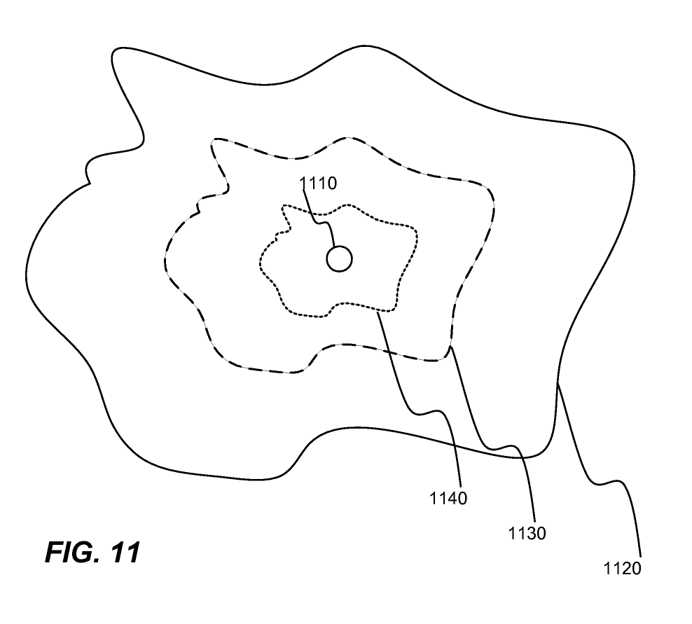

FIG. 11 illustrates interference based on transmit power for nodes. Individual nodes may be able to make individual selections for operating frequency and power level based on their own local interference conditions. In general, the interference is proportional to the transmit power level of the DySAN node. At a reduced power level, a greater range of frequencies are available for sharing. A technique is described herein to select the transmit power and transmit frequency for the node based on available spectrum such that the potential for interference to surrounding wireless networks is minimized. Minimizing the power levels of signals that could interfere with surrounding networks may increase the geographic region where co-channel and adjacent channel frequencies may be used by a DySAN network. Using lower power levels may also make more frequency spectrum available for use by the DySAN network. As a significant advantage, power levels may be adjusted to reduce interference to users in other networks within the spectrum of interest, but not within the DySAN network. Alternatively, a variety of techniques can be used to tune the aggressiveness of the DySAN algorithms to adjust to the local interference conditions such as by balancing the ability to find sufficient operating spectrum with the amount of interference caused to an external network. Data may be transmitted from the node to one or more other nodes using the selected transmit power and transmit frequency.

When a node transmits, it has the potential to create interference in a geographic region over the occupied radio frequency. The size of the area where interference may be caused is proportional to the transmit power. As depicted, a node 1110 may transmit at a high power, a medium power, or a low power. A first region 1120 represents the area over which interference may occur when the node 1110 transmits at a high power. The first region 1120 also shows the geographic extent of interference when the node 1110 is tuned for increased aggressiveness to secure operating spectrum. A second region 1130 represents the area over which interference may occur when the node 1110 transmits at a medium power. The second region 1130 also shows the geographic extent of interference when the node 1110 is tuned for normal conditions in trying to secure operating spectrum. The third region 1140 represents the area over which interference may occur when the node 1110 transmits at a low power. The third region 1140 also shows the geographic extent of interference when the node 1110 is tuned for decreased aggressiveness to secure operating spectrum. With such a decreased aggressiveness a transmitting node provides more area and frequency availability to neighboring nodes. Such a decreased aggressiveness tuning may therefore be considered a “good neighbor” mode. In some embodiments, light spectrum usage may be known or detected. In this case, higher power and more aggressive tuning may be utilized since there may be little possibility for interference.

In some embodiments higher frequency congestion may be known or detected. In this case, lower power and less aggressive tuning may be utilized since there may be ample opportunity for interference. The aggressiveness may be adjusted based on detected frequency spectrum information or may be adjusted based on known rules for a given geographical area. In some embodiments, aggressiveness and preferred power settings may be based on criticality of data or priority of data. Likewise, frequency usage may be adjusted based on aggressiveness where the same or close frequencies, to those of geographically nearby networks, may be used when a greater aggressiveness is allowable. Thus the transmit power and transmit frequency may be selected to control interference by the node with one or more other wireless networks such as with frequency-agile networks and cellular telephony networks.

It will be understood that a variety of parameters may be controlled to adjust an aggressiveness with which a node seeks to use available spectrum in a network. For example, a sense duration and sense interval may be adjusted to tune aggressiveness. In such embodiments, the node 1110 may schedule longer periods of sensing for itself and/or other nodes such as one-hop neighbors. This permits the node 1110 to identify intermittent interfering signals and relatively weak signals that might not prohibit use of a frequency band. In another aspect, the sense interval may be adjusted so that the node 1110 schedules sensing more frequently in an effort to more aggressively identify unused spectrum. In another aspect, a delay before releasing spectrum to other users may be adjusted to tune aggressiveness.

In another aspect, aggressiveness may be tuned independently and/or differently at each node in a network. In one aspect, aggressiveness may be based upon a spectrum use interpretation such as by distinguishing primary networks and users (e.g., cellular telephony networks or the like) from other continuous and intermittent users as well as noise and distant signals. The spectrum use interpretation may be adjusted by modifying a time decay factor. The aggressiveness may be tuned according to a threshold degradation for an external network. An external network may notify the DySAN network that it is causing interference. The DySAN network may, in response, reduce aggressiveness until interference with the external network is eliminated.

In another aspect, aggressiveness may be multi-factored. For example, a specified value for aggressiveness may be used to select multiple operating characteristics. For example, a specified value may determine the operating power for each node (e.g., low power for low aggressiveness). The specified value may also or instead control how frequently a node or group of nodes search for available spectrum. The specified value may also or instead control whether a node will attempt using a frequency that has other users. The specified value may also or instead control whether the node will increase signal strength to successfully transmit in the presence of other users. The specified value may also or instead control how close to neighboring frequencies the node can transmit, and/or whether the node will transmit in immediately adjacent or overlapping frequency bands. Thus in general, a node may evaluate spectral energy (e.g., during a sense duration as described below) and select frequencies and power (or powers, where possible for multiple bands) based upon a single aggressiveness setting. In other embodiments, each type of aggressiveness may be independently tuned according to a relative scale (e.g., 1 to 5), or with specific values for various operating characteristics (e.g., a specific power setting, etc.). Any of the foregoing may be used alone or in combination to control an aggressiveness with which a node seeks to use available spectrum.

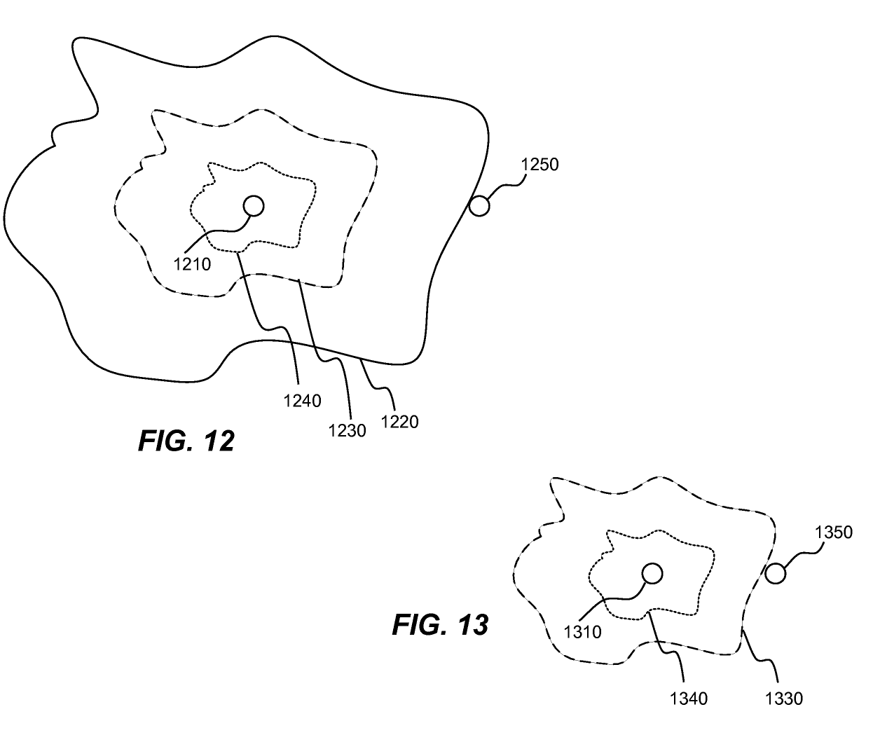

FIGS. 12 and 13 show how a smaller interference region allows a DySAN node to operate closer to a primary spectrum user as the transmit power is reduced. The transmit power may be adjusted as a result of several methods. It may be pre-programmed for certain allowed transmit power levels based on the geographic location of the node, or it may receive power level commands from some external source. One method is to adjust the transmit power based on the detected RF energy in the spectrum. Energy detection on a frequency channel indicates the presence of a transmitter. In communications systems, the presence of a transmitter also indicates the presence of a receiver that may be susceptible to interference from a DySAN node. A stronger sensed power level indicates a smaller path loss between the nodes in the two networks. A weaker sensed power level indicates a larger loss between the nodes in the two networks, indicating that a greater transmit power level can be used before causing interference.

A node may make its own determination of transmit power based on its own sensed spectrum levels. Another method is for a node to act as the ‘master’ node for a collection of nodes in the network. Such a master node could be located at a stationary location or be placed with a height advantage that provides improved propagation to the surroundings. In some embodiments the master node may determine the transmit power and the transmit frequency with these values being communicated to other nodes in the network.

The determination of transmit power may be based on the total power in a given frequency channel. Since the occupied bandwidths of a primary spectrum user and a DySAN network node may differ, the determination of transmit power may be based on the power densities in the overlapping portion of the network bandwidths. The determined power density may then be applied to the full DySAN bandwidth to determine the total transmit power.

FIG. 12 shows a node 1210 that is transmitting at a high power level. A first region 1220 represents the area over which interference may occur when the node 1210 transmits at such a high power. A second region 1230 represents the area over which interference may occur when the node 1210 transmits at a medium or normal power. A third region 1240 represents the area over which interference may occur when the node 1210 transmits at a low power. A primary spectrum user node 1250 is shown outside of the region 1220. If the primary spectrum user node 1250 had been positioned closer to the node 1210 then interference between the primary spectrum user node 1250 and the node 1210 may exceed tolerable limits for the network in which the node 1210 operates or for the network in which the primary spectrum user node 1250 operates.

FIG. 13 shows a node 1310 that is transmitting at a normal or medium power level. A first region 1330 represents the area over which interference may occur when the node 1310 transmits at a medium or normal power. A second region 1340 represents the area over which interference may occur when node 1310 transmits at a low power. A primary spectrum user node 1350 is shown outside of the first region 1330. If the primary spectrum user node 1350 were positioned closer to the node 1310 then interference between the primary spectrum user nodes 1350 and the node 1310 may exceed tolerable limits for the network in which the node 1310 operates or the network in which the primary spectrum user node 1350 operates. If the primary spectrum user node 1350 needs to be closer to the node 1310, then the node 1310 would need to transition to a lower power level in order to avoid unacceptable interference. Further, in some embodiments, power may be selected using estimated link loss and a modulation mode selected to ensure the needed signal is above a threshold at a receiving node.

Determination of interference potential may also depend on the methods in which frequencies are used in different networks. Interference may occur on co-channel or adjacent channel frequencies. Additionally, in frequency-division duplex (FDD) systems, different frequencies may be used for transmission and reception by a single node or radio terminal. In order to determine the transmit power, the DySAN node may consider the power levels in the co-channel, adjacent channel, paired co-channel, and paired adjacent channel frequencies. Further, the spectral distance between frequencies may be factored in when considering interference potential. In general, aggressiveness tuning of a node may consider adjusting a transmit frequency of a node to avoid interference. Aggressiveness tuning may also consider co-channels, adjacent channels, frequency spacing and the like as they relate to the detected usage when determining where spectrum is available for a node. Thus, when a node obtains spectral information, the measured spectral energy may be further analyzed in a number of ways to identify useable spectrum based on existing spectral energy as well as other information about various types of spectrum users and the requirements for such users.

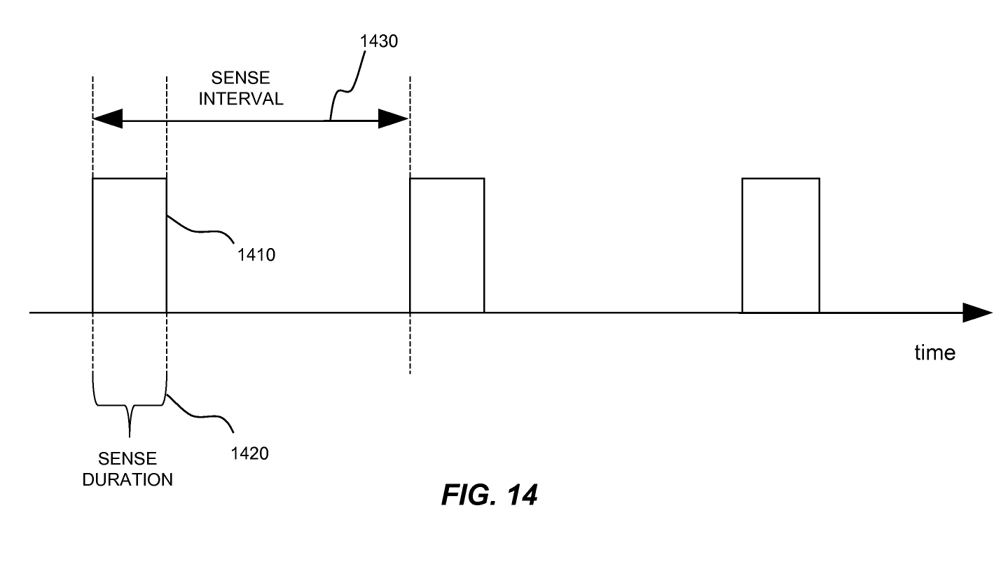

FIG. 14 illustrates timing for spectral energy sensing. A DySAN network may periodically pause all radio activity to provide a period of silence (from the node(s) in the DySAN) during which other spectral energy in a frequency spectrum can be measured. This pause 1410 in radio activity may have a sense duration 1420 during which time all nodes are silent so that each node can sense the frequency spectrum in order to search for other spectrum users. This pause 1410 may also repeat periodically, such as once per sense interval 1430, which represents the time elapsed between the beginning of sequential sense durations 1420. During the pause 1410, all transmissions by nodes may be discontinued so that the nodes can in turn detect frequency spectrum usage. During the sense duration 1420 the available spectrum based upon radio frequency energy within the frequency spectrum is sensed. The sense duration 1420 and the sense interval 1430 may be controlled at a node with parameters that represent the time duration for each. These values may also be represented as a schedule of discrete starting and stopping times, or in any other manner suitable for storage on and execution by the node(s). In general, these parameters may be controlled to adjust the aggressiveness with which a node seeks to identify and/or use unoccupied spectrum. The sense duration 1420 and the sense interval 1430 may be communicated to all nodes in a network, or to a local neighborhood such as one-hop neighbors and/or two-hop neighbors of a node. A transmit power and a transmit frequency may be selected for the node based on the available spectrum. In some embodiments a sense interval 1430 may be selected based on a function of the available spectrum and one or more characteristics of the wireless ad hoc network. In some embodiments selecting the sense interval includes tuning for aggressiveness of the node by controlling the frequency of occurrence of the sense duration, i.e., how frequently each node re-checks for available spectrum.

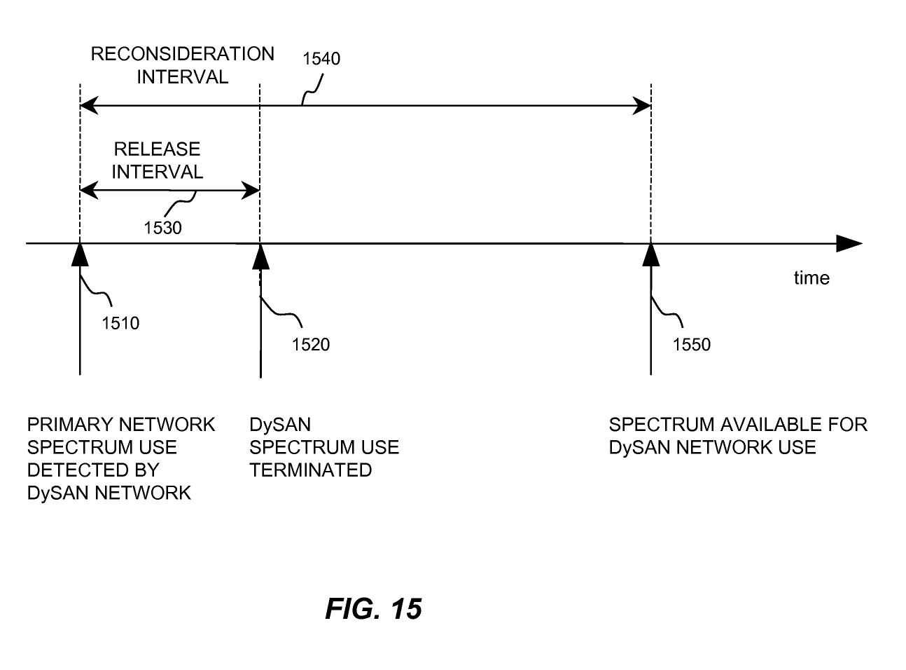

FIG. 15 shows the use of release and reconsideration intervals for tunable aggressiveness in a shared spectrum. Upon detection of the presence of a spectrum user with higher priority access to a spectrum (indicated as a first event 1510), a DySAN network may release the frequency of that spectrum by ceasing transmitting (shown as a second event 1520) within the corresponding frequency range. The delay between when spectrum use is detected and the release of frequency spectrum by the DySAN network is a release interval 1530. Once external activity has been detected on a portion of spectrum, a DySAN network may reconsider use of that portion of spectrum at some predetermined time (a reconsideration interval 1540) after the spectrum use was first detected. After the reconsideration interval 1540, the frequency spectrum is considered available for DySAN network use (as indicated by a third event 1550) or for evaluation of possible use. The values for the release interval 1530 and the reconsideration interval 1540 may be controlled by a node to determine how quickly the node attempts to reuse spectrum that is occupied by a higher priority user.

A network consists of multiple nodes that have the capability of operating differently from one another. In one embodiment all nodes in a network may use the same level of tuned aggressiveness. An alternative embodiment for tuning the aggressiveness of a network is by having individual nodes each operate with varying aggressiveness levels. Individual node aggressiveness may be adjusted based on local node conditions for spectrum availability.

In DySAN networks, spectrum use may be sensed by the nodes to assess spectrum use by external networks and spectrum availability for use by the DySAN network. The evaluation of possible spectrum use by an external network is based on partial observations of spectrum usage. A method for tuning the aggressiveness of the network includes adjusting how often evaluation of spectrum use occurs. For example, a frequency spectrum decay rate decay rate may be adjusted to evaluate spectrum availability more or less aggressively. Once frequency spectrum use is sensed it may be determined how long to wait before reevaluating frequency spectrum usage. A frequency spectrum may be considered to only reduce slowly over time in which case a slow decay rate is used. If frequency spectrum usage is considered to change quickly then a fast decay rate may be used. Once a certain amount of frequency spectrum reduction is expected to be possible, based on a calculation employing the appropriate frequency spectrum decay rate, frequency spectrum may be evaluated for availability. If a fast frequency spectrum is used, the network may be considered to be tuned to be more aggressive.

A DySAN network may compute it's transmit power based on causing no more than a specified amount of threshold degradation to an external network. The amount of threshold degradation may be changed to allow more or less interference power into an external network. More aggressive tuning for the DySAN network may be achieved by allowing an increased amount of threshold degradation to an external network. The result would be reflected in an increased transmit power computation for the DySAN network.

A method for determining how to adjust the aggressiveness is to provide a communications path between networks that are sharing common spectrum. In this manner, a non-DySAN network may signal a DySAN network when interference is actually being caused. When so indicated, the DySAN network may back-off its aggressiveness to reduce or eliminate the interference caused to the non-DySAN network. When both networks are connected to a common wired network (e.g., the internet), this communications may occur over that wired network. In some embodiments, the sense duration and sensing of the frequency spectrum may be performed outside the network and communicated to the node through a wired or wireless connection. An alternative embodiment would be to communicate directly over a wireless interface between nodes in each network.

The ability to adapt the dynamic spectrum access algorithms may provide increased flexibility and performance to the DySAN network. In situations where available spectrum is smaller than required for carrying data, the network may adjust its parameters to temporarily increase the potential amount of interference tolerated from surrounding networks. When the surrounding networks are controlled by a common business entity, this method provides an ability to optimize network performance across the multiple networks by dynamically shifting bandwidth (i.e., capacity) between networks, even if the other network is not spectrally adaptive. A tunable level of aggressiveness may allow the network operator to adjust for real-world field conditions to account for scenarios not anticipated prior to deployment without having to design for a cascading set of worst-case assumptions. This embodiment may, for example, provide increased overall spectral efficiency, or provide guaranteed minimum availability to a particular network.

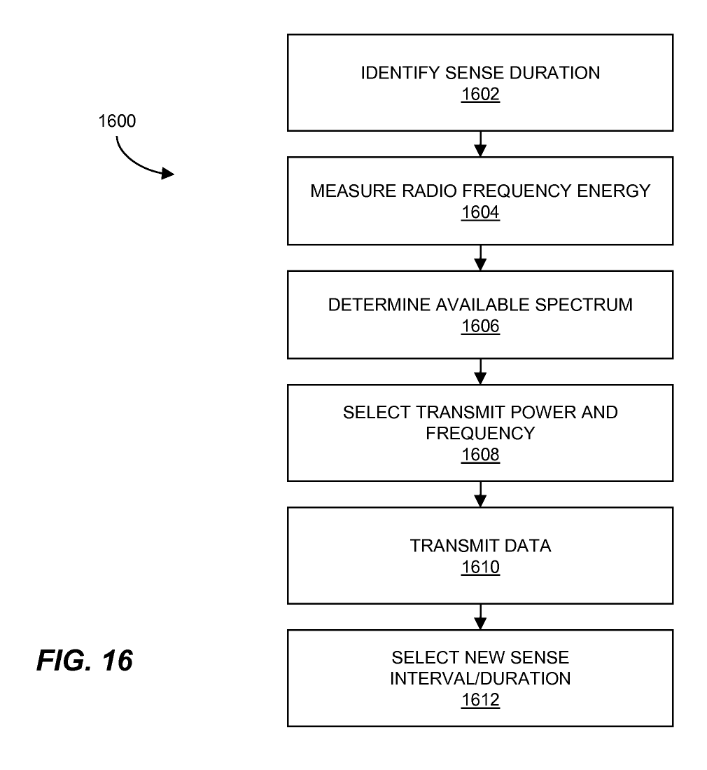

FIG. 16 shows a method for controlling spectrum usage by a node in a wireless network. In general, the method 1600 may be used to operate a node in a wireless ad hoc network that includes a plurality of nodes capable of changing an operating frequency and a power level, such as a DySAN or other frequency-agile network, or group of nodes using a corresponding frequency-agile protocol for communications. The plurality of nodes may consist of the node and some other group of nodes such as a one-hop neighborhood of other nodes, a two-hop neighborhood of other nodes, or some other neighborhood or other group of nodes.

As shown in step 1602, the method 1600 may begin with identifying a sense duration during which each one of the plurality of nodes is silent. This may include coordination among a plurality of nodes to select a time and length for a sense duration among the nodes. In another aspect, the sense duration may be specified by an outside source and transmitted to the node by a wire or wireless connection. This may be, for example, a master node among a group of wireless nodes, which may advantageously be a node at a high elevation or otherwise physically positioned to have an unobstructed signal path with nodes within and/or without the network.

As shown in step 1604, the method 1600 may include sensing a frequency spectrum during the sense duration. This may include listening with the radio of the node, or otherwise measuring radio frequency energy across the frequency spectrum of interest. Identifying the sense duration and/or sensing the frequency spectrum may usefully be performed outside the plurality of nodes and communicated to the node through a non-network connection such as a wired connection, a wireless connection to another network, or a connection to any other remote source such as a base station, a master node, a backhaul access point, an edge router, a cellular telephony network, a wide area network, and so forth.

As shown in step 1606, the method 1600 may include determining an available spectrum based upon radio frequency energy within the frequency spectrum. This may include applying any number of criteria and analyses to the measured spectrum and may account for specific types of users and communication channels, all as generally discussed above.

As shown in step 1608, the method 1600 may include selecting a transmit power and a transmit frequency for the node based on the available spectrum. The selection may be based upon a variety of factors. This may include, for example an aggressiveness metric that determines whether and to what extent a node should use a greater transmit power, and whether and to what extent a node should use a transmit frequency this is actually or potentially occupied by another network. Selecting the transmit power and the transmit frequency may also or instead include controlling interference by the node with one or more other wireless networks as generally described above, such as a frequency-agile network or a cellular telephony network. More generally, any of the techniques described above may be usefully employed to select a transmit power and a transmit frequency (or frequencies) for the node. The transmit power and the transmit frequency may be stored in a memory of the node for subsequent use, which may be processor memory or any other volatile or non-volatile memory device(s) described herein. In one aspect, the preceding steps may be performed by a different node or other system and transmitted to the node, either as spectrum information used to determine power and frequency, or as an explicit power and frequency selection that the node is to apply. In another aspect, the node may be a master node that determines a specific transmit power and/or transmit frequency and communicates the transmit power and/or the transmit frequency to one or more other ones of the plurality of nodes.

As shown in step 1610, the method 1600 may include transmitting data from the node to one or more other ones of the plurality of nodes using the transmit power and transmit frequency. In general, this includes retrieving the power and frequency parameters and controlling a radio of the node to transmit data (such as from a data source of the node) using the corresponding spectrum.

As shown in step 1612, the method 1600 may include selecting a sense interval to determine when a next sense duration occurs based upon a function of the available spectrum and one or more characteristics of the wireless ad hoc network. This may also include defining a length for the sense duration and/or a length for the sense interval to be used by the node in the next sense interval and communicating this information to one or more of the plurality of nodes for use in a new, shared sense interval. The sense interval may, for example, be based on an aggressiveness value or setting for the node, or any other criterion or criteria as generally discussed above.

It will be understood that the method 1600 described above is set forth by way of example and not of limitation. Numerous variations, additions, omissions, and other modifications will be apparent to one of ordinary skill in the art. In addition, the order of presentation of these steps in the description and drawings is not intended to require this order of performing the recited steps unless a particular order is expressly required or otherwise clear from the context. All such variations are intended to fall within the scope of this disclosure. In addition, the method 1600 may be embodied in a device including, e.g., a radio and a data source as described above, as well as a processor (which may be any of the programmable device(s) described herein) programmed to perform any or all of the steps described above. In addition, the method 1600 may be embodied in computer programmable code that when executing on one or more computing devices performs the recited steps. Thus the foregoing description is not limiting, and should be interpreted broadly to include all suitable variations, as well as all embodiments of the subject matter allowable by law.

It will be appreciated that any of the above systems, apparatuses, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices, along with internal and/or external memory such as read-only memory, programmable read-only memory, electronically erasable programmable read-only memory, random access memory, dynamic random access memory, double data rate random access memory, Rambus direct random access memory, flash memory, and/or any other volatile or non-volatile memory for storing program instructions, program data, and program output or other intermediate or final results. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as a camera and/or computer and/or server or other remote processing resource in a number of ways, or all of the functionality may be integrated into a dedicated, standalone device. All such permutations and combinations are intended to fall within the scope of the present disclosure.

In other embodiments, disclosed herein are computer program products comprising computer-executable code or computer-usable code that, when executing on one or more computing devices, performs any and/or all of the steps described above. The code may be stored in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the processes described above may be embodied in any suitable transmission or propagation medium carrying the computer-executable code described above and/or any inputs or outputs from same.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

1-20. (canceled)

21. A method for operating a node in a wireless ad hoc network that includes a plurality of frequency-agile nodes that periodically change operating frequency comprising:
receiving a negotiation message from a neighbor at the node in the wireless ad hoc network having a node frequency and a node frequency change precedence indicator (node FCPI), the negotiation message including a new neighbor frequency that identifies a frequency that the neighbor will change to, a countdown indicator that identifies when the neighbor will change to the new neighbor frequency, and a neighbor frequency change precedence indicator (neighbor FCPI) that assigns a precedence to the frequency selected by the neighbor;
conditionally updating the node frequency to the new neighbor frequency when the new neighbor frequency is different from the node frequency and the node FCPI is less than the neighbor FCPI, thereby providing an updated node frequency; and
changing the node to the updated node frequency.

22. The method of claim 21 further comprising updating the node FCPI to equal the greater of the neighbor FCPI and the node FCPI when the new neighbor frequency is the same as the node frequency, thereby providing an updated node FCPI.

23. The method of claim 22 further comprising transmitting the updated node FCPI to one or more neighbors of the node.

24. The method of claim 21 further comprising determining whether the new neighbor frequency is acceptable for the node before changing the node to the updated node frequency.

25. The method of claim 24 further comprising updating the node FCPI to equal the greater of the neighbor FCPI and the node FCPI plus an increment, thereby providing an updated node FCPI.

26. The method of claim 25 further comprising transmitting the updated node FCPI to one or more neighbors of the node.

27. The method of claim 21 wherein the wireless ad hoc network is a dynamic spectrum access network that dynamically allocates spectrum usage according to availability.

28. The method of claim 21 wherein changing the node to the updated node frequency includes changing the node concurrently with the neighbor changing to the new neighbor frequency.

29. The method of claim 21 further comprising controlling a frequency use by the node to avoid a frequency spectrum occupied by a primary network.

30. The method of claim 29 wherein the primary network includes a cellular telephony network.

31. A node in a wireless ad hoc network that includes a plurality of frequency-agile nodes that periodically change operating frequency comprising:
a data source;
a radio for operating the node within the wireless ad hoc network using a frequency-agile protocol;
a memory storing a node frequency and a node frequency change precedence indicator (node FCPI) for the node; and
a processor programmed to receiving a negotiation message from a neighbor, the negotiation message including a new neighbor frequency that identifies a frequency that the neighbor will change to, a countdown indicator that identifies when the neighbor will change to the new neighbor frequency, and a neighbor frequency change precedence indicator (neighbor FCPI) that assigns a precedence to the frequency selected by the neighbor, the processor further programmed to conditionally update the node frequency to the new neighbor frequency when the new neighbor frequency is different from the node frequency and the node FCPI is less than the neighbor FCPI, thereby providing an updated node frequency, and the processor further programmed to change the node to the updated node frequency.

32. The node of claim 31 wherein the processor is further programmed to update the node FCPI to equal the greater of the neighbor FCPI and the node FCPI when the new neighbor frequency is the same as the node frequency, thereby providing an updated node FCPI.

33. The node of claim 32 wherein the processor is further programmed to transmit the updated node FCPI to one or more neighbors of the node using the radio.

34. The node of claim 31 wherein the processor is further programmed to determine whether the new neighbor frequency is acceptable for the node before changing the node to the updated node frequency.

35. The node of claim 34 wherein the processor is further programmed to update the node FCPI to equal the greater of the neighbor FCPI and the node FCPI plus an increment, thereby providing an updated node FCPI.

36. The node of claim 35 wherein the processor is further programmed to transmit the updated node FCPI to one or more neighbors of the node using the radio.

37. The node of claim 31 wherein the wireless ad hoc network is a dynamic spectrum access network that dynamically allocates spectrum usage according to availability.

38. The node of claim 31 wherein the processor is programmed to change the node to the updated node frequency concurrently with the neighbor changing to the new neighbor frequency.

39. The node of claim 31 wherein the processor is programmed to control a frequency use by the node to avoid a frequency spectrum occupied by a primary network.

40. The node of claim 39 wherein the primary network includes a cellular telephony network.

41-60. (canceled)
